(19) United States
(12) Patent Application Publication
(10) Pub. No.: US 2015/0106148 A1
(43) Pub. Date: Apr. 16, 2015

(54) Business Introduction Tool

(71) Applicant: BIZINTRO, Manhattan, IL (US)

(72) Inventor: Steven Thomas, Manhattan, IL (US)

(73) Assignee: BIZINTRO, Manhattan, IL (US)

(21) Appl. No.: 14/052,480

(22) Filed: Oct. 11, 2013

(51) Int. Cl. G06Q 50/00; G06Q 10/10

(52) U.S. Cl. CPC G06Q 50/01; G06Q 10/1093
USPC 705/7.19; 705/319

(57) ABSTRACT

A method for managing business introductions includes retrieving unfiltered data generated by a professional networking service and filtering a plurality of business connections to generate a filtered list of business connections. The filtered list of connections to send to an end user device, and a selected connection is subsequently received. The method further includes generating a draft message to a business contact requesting an introduction to the selected connection and sending the draft message to the end user device. Once a revised message is received from the end user device, a server sends the revised message to the business contact.

### TECHNICAL FIELD

The present disclosure generally relates to a method for aggregating professional network data and, more particularly, to a method for facilitating effective business interactions.

### BACKGROUND

Professional networking and other social media websites are currently gaining exposure and prominence in the life of business professionals. For example, many business professionals use such sites to maintain a list of professional contacts, endorse or recommend colleagues, search for jobs, etc. These sites can be advantageous in growing a business and building a valuable network of professional connections.

However, the data generated and displayed by professional networking sites is often overwhelming to users in that users are presented with large lists of their many immediate contacts, even larger lists of close contacts (e.g., people to whom they are connected via immediate contacts), and a vast range of parameters (e.g., job function, location, etc.) associated with contacts. If, for example, a business professional would like to reach out to sales leads, the business professional can spend a significant amount of time searching for high potential leads, writing messages to those leads, keeping track of sent messages/responses, etc. Moreover, due to a lack of intuitive design, cohesiveness, and efficiency, potential business leads are often reluctant to spend time on a site responding to business introductions or messages from unknown individuals.

### SUMMARY

In one embodiment, a computer-implemented method for managing business introductions comprises retrieving, with one or more processors, unfiltered data generated by a professional networking service, the unfiltered data indicating a plurality of business connections, filtering, with the one or more processors, the plurality of business connections to generate a filtered list of business connections, wherein each connection in the filtered list of connections matches a keyword, and sending, via a network interface, the filtered list of connections to the end user device. Further the method comprises receiving, via the network interface, a selected connection from among the list of filtered connections, generating, with the one or more processors, a draft message to a business contact requesting an introduction to the selected connection, wherein the draft message is generated based on a message template, and sending, via the network interface, the draft message to the end user device. Still further, the method comprises receiving, via the network interface, a revised message to the business contact, wherein the revised message is based on the draft message, and sending, via the network interface, the revised message to the business contact.

In another embodiment, computer device managing business introductions comprises one or more processors and one or more non-transitory memories coupled to the one or more processors, wherein the one or more memories include computer executable instructions stored therein that, when executed by the one or more processors, cause the one or more processors to retrieve unfiltered data generated by a professional networking service, the unfiltered data indicating a plurality of business connections. Further, the computer executable instructions cause the one or more processors to filter the plurality of business connections to generate a filtered list of business connections, wherein each connection in the filtered list of connections matches a keyword, send, via a network interface, the filtered list of connections to the end user device, and receive, via the network interface, a selected connection from among the list of filtered connections. Still further, the computer executable instructions cause the one or more processors to generate a draft message to a business contact requesting an introduction to the selected connection, wherein the draft message is generated based on a message template, send, via the network interface, the draft message to the end user device, receive, via the network interface, a revised message to the business contact, wherein the revised message is based on the draft message, and send, via the network interface, the revised message to the business contact.

### BRIEF DESCRIPTION OF THE DRAWINGS

FIG. 1 illustrates an example computing environment for managing effective business introductions based on filtered data from a professional networking, or social media, website.

FIG. 2 is a block diagram of an example implementation of the business introduction server illustrated in FIG. 1.

FIG. 3 is a flow diagram of an example method for subscribing to a business introduction tool which may be implemented by the business introduction server illustrated in FIG. 1.

FIGS. 4A-4I are example screenshots of business introduction tool web pages utilized as part of a subscription method such as the method of FIG. 3.

FIG. 5 is a flow diagram of an example method for filtering data from a professional network which may be implemented by the business introduction server illustrated in FIG. 1.

FIGS. 6A-6G are example screenshots of business introduction tool web pages displayed filtered data which may be generated as part of the method of FIG. 5.

FIG. 7 is an example method for facilitating business introduction which may be implemented by the business introduction server illustrated in FIG. 1.

FIGS. 8A-8I are example screenshots of business introduction tool web pages utilized as part of a business introduction method such as the method of FIG. 7.

FIGS. 9A-9E are example screenshots of business introduction tool web pages utilized to manage business introduction such as those facilitated with the method of FIG. 7.

FIGS. 10A-10E are example screenshots of business introduction tool web pages utilized as part of a business help method which may be implemented by the business introduction server illustrated in FIG. 1.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such terms should not be interpreted to be limited in scope based on any statement made in any section of this patent (other than the language of the claims). To the extent that any term recited in the claims at the end of this patent is referred to in this patent in a manner consistent with a single meaning, that is done for the sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

### System Overview

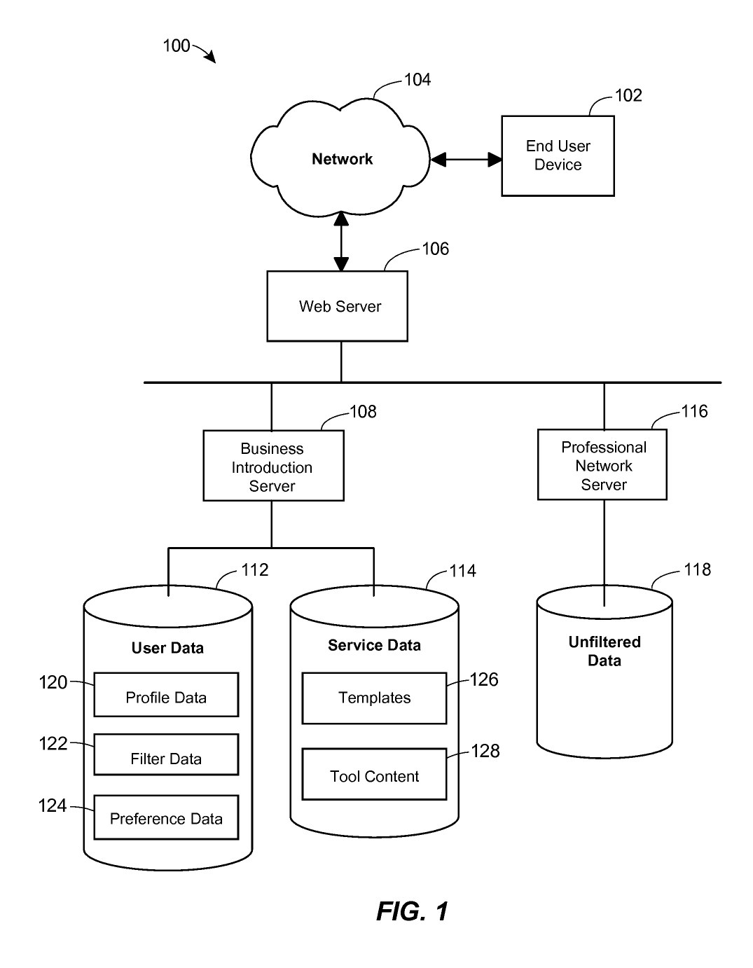

FIG. 1 illustrates an example computing environment 100 to manage and facilitate effective business introductions based on filtered data from a professional networking, or social media, website. A user of an end user device 102 is communicatively coupled, via one or more wired or wireless interfaces, to a network 104 and a web server 106. The end user device may include any suitable computing device such as a personal computer, smartphone, tablet computer, etc. The network 104 may be a proprietary network, a secure public internet, a virtual private network or some other type of network, such as dedicated access lines, plain ordinary telephone lines, satellite links, combinations of these, etc. Where the network 104 comprises the Internet, data communications may take place over the network 104 via an Internet communication protocol.

The web server 106 may be implemented in one of several known configurations via one or more servers configured to process web-based traffic received via the network 104 and may include load balancing, edge caching, proxy services, authentication services, etc.

In an implementation, the end user device 102 is capable of executing a graphical interface (GUI) for a business introduction tool within a web browser application, such as Apple's Safari®, Google Android™ mobile web browser, Microsoft Internet Explorer®, etc. The web browser application may be implemented as a series of machine-readable instructions for receiving, interpreting, and displaying web page information from the web server 106 while also receiving inputs from the user. Further, those skilled in the art will recognize that the present system can be used in a dedicated application in addition to a web browser.

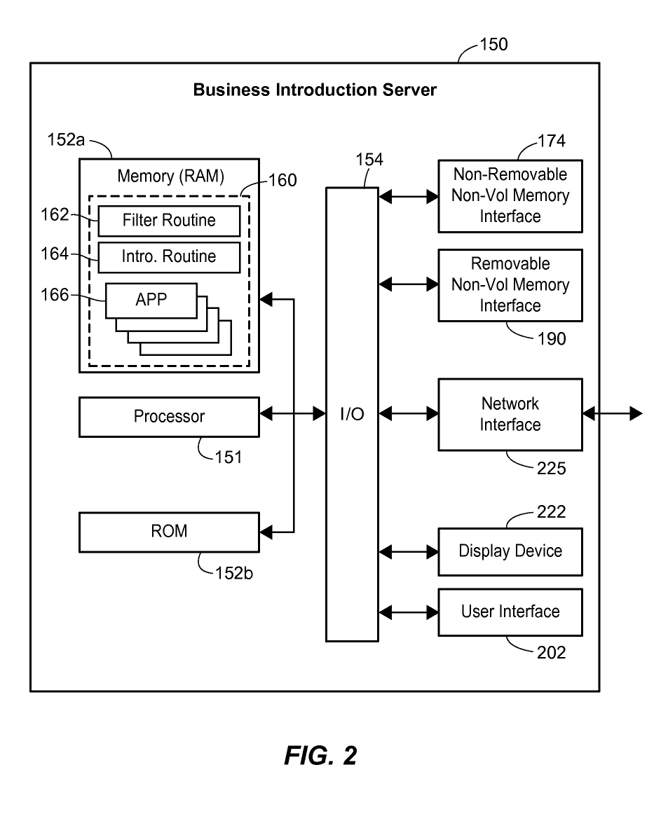

A business introduction server 108 may include a number of software applications responsible for generating business introduction tool content to be included in the web pages sent from the web server 106 to the end user device 102. For example, the business introduction server 108 may generate filtered contact lists, message interfaces, forms, tables, etc. as discussed below, to be included in the web pages sent to the end user device 102. The details of an implementation of the business introduction server 108 are discussed in more detail with reference with FIG. 2. Further, although FIG. 1 illustrates one business introduction server 108, the techniques of the present disclosure may be implemented by any number of servers with any number of processors, such as in a “cloud computing” implementation.

In some implementations, the business introduction server 108 is operatively connected to a user database 112 and a service database 114. However, it should be noted that, while not shown, additional database may be operatively connected to the business introduction server 108 and/or the databases 112 and 114 may be combined into a single database or data structure. Further, the business introduction server 108 is communicatively coupled to data generated by a professional networking server 116 and stored in an unfiltered database 118, in an implementation. For example, the professional networking server 116 may generate content for a professional networking, or social media, tool to be included in the web pages sent from the web server 106 to the end user device 102. Further, the professional networking server 116 may receive, track, and update data (e.g., stored in the unfiltered database 118) about business professionals subscribed to the professional networking tool, connections between business professionals (e.g., connected through certain individuals, connected by location, etc.), etc., in an implementation.

The user database 112 may be, for example, configured to store: (i) a plurality of profile data 120 corresponding to users of the business introduction tool (e.g., usernames, passwords, payment information, etc.); (ii) a plurality of filter data 122 corresponding to certain users and representing saved filters for filtering data from the unfiltered database 118; and (iii) a plurality of preference data 124 corresponding to certain users and representing saved calendar, time zone, payment, email template, etc. preferences for use in the business introduction tool. The service database 114 may be, for example, configured to store: (i) a plurality of templates 126 for sending messages between business contacts, where the plurality of templates 126 may be optionally modified by the plurality of preference data 124; and (ii) a plurality of tool content 128 for generating content to be included in the web pages sent from the web server 106 to the end user device 102.

FIG. 2 illustrates an example business introduction server 150 that may manage business introductions and generate business introduction tool content for display on an end user device. The business introduction server 150 may be implemented as the business introduction server 108 in the example computing system 100, for example. The business introduction server 150 may include one or more processing units, 151, a system memory, 152a and 152b, and a system bus 154 that couples various system components including the system memory 152 to the processing units 151. The system bus 154 may include an Industry Standard Architecture (ISA) bus, a Micro Channel Architecture (MCA) bus, Enhanced ISA (EISA) bus, Video Electronics Standards Association (VESA) local bus, a Peripheral Component Interconnect (PCI) bus or a Mezzanine bus, and the Peripheral Component Interconnect Express (PCI-E) bus.

The business introduction server 150 may include an assortment of computer-readable media. Computer-readable media may be any media that may be accessed by the business introduction server 150. By way of example, and not limitation, the media may include both volatile and nonvolatile media, removable and non-removable media. Media may also include computer storage media and communication media. Computer storage media may include volatile and nonvolatile, removable and non-removable media that stores information such as computer-readable instructions, program modules, data structures, or other data. Computer-storage media may include RAM, ROM, EEPROM, or other memory technology, optical storage disks, magnetic storage devices, and any other medium which may be used to store computer-accessible information. Communication media may be computer-readable instructions, data structures, program modules, or other data in a modulated data signal or other transport mechanism. Communication media may include wired media such as a wired network or direct-wired connection, and wireless media such as RF, infrared, and other wireless media.

The system memory may include storage media in the form of volatile and/or non-volatile memory such as ROM 152a and RAM 152b. A basic input/output system (BIOS), containing algorithms to transfer information between components within the computer 150, may be stored in ROM 152b. Data or program modules that are immediately accessible or are presently in use by the processing units 151 may be stored in RAM 152a. Data normally stored in RAM 152a while the business introduction server 150 is in operation may include an operating system, application programs, program modules, and program data. In particular, the RAM 152a may store a business introduction tool program 160 including a filter routine 162, introduction routine 164, and various other applications 166 (e.g., calendar application, spreadsheet application, etc.) integrated into the business introduction tool program 160, for example.

The business introduction server 150 may also include other storage media such as a hard disk drive that may read from or write to non-removable, non-volatile magnetic media, a magnetic disk drive that reads from or writes to a removable, non-volatile magnetic disk, and an optical disk drive that reads from or writes to a removable, nonvolatile optical disk. Other storage media that may be used includes magnetic tape cassettes, flash memory cards, digital versatile disks, digital video tape, solid state RAM, and solid state ROM. The hard disk drive may be connected to the system bus 154 through a non-removable memory interface such as interface 174. A magnetic disk drive and optical disk drive may be connected to the system bus 154 by a removable memory interface, such as interface 190.

A user may interact with the business introduction server 150 through input devices such as a keyboard or a pointing device (i.e., a mouse). A user input interface 202 may be coupled to the system bus 154 to allow the input devices to communicate with the processing units 151. A display device 222, such as a monitor, may also be connected to the system bus 154 via a video interface (not shown).

The business introduction server 150 may operate in a networked environment using logical connections to one or more remote computing devices, such as end user device 102, web server 106, or cost estimation server 125, for example. The remote computing device may be a personal computer (PC), a server, a router, or other common network node. The remote computing device typically includes many or all of the previously-described elements regarding the business introduction server 150, even though such elements are not illustrated in the remote computing devices of FIG. 1. Logical connections between the business introduction server 150 and one or more remote computing devices may include a wide area network (WAN). A typical WAN is the Internet. When used in a WAN, the business introduction server 150 may include a modem or other means for establishing communications over the WAN. The modem may be connected to the system bus 154 via the network interface 225, or other mechanism. In a networked environment, program modules depicted relative to the business introduction server 150, may be stored in the remote memory storage device. As may be appreciated, other means of establishing a communications link between the computer 150 and a remote computing device may be used.

### Subscription Process

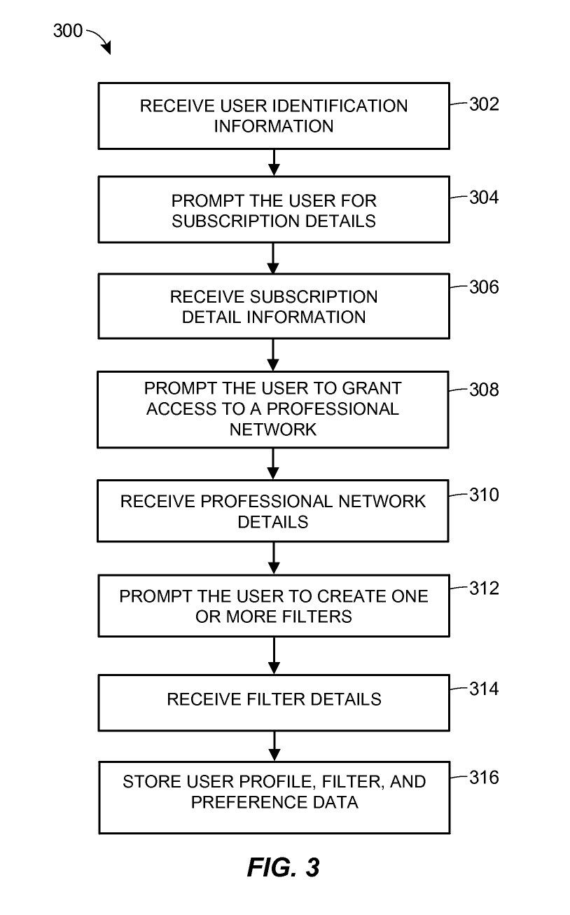

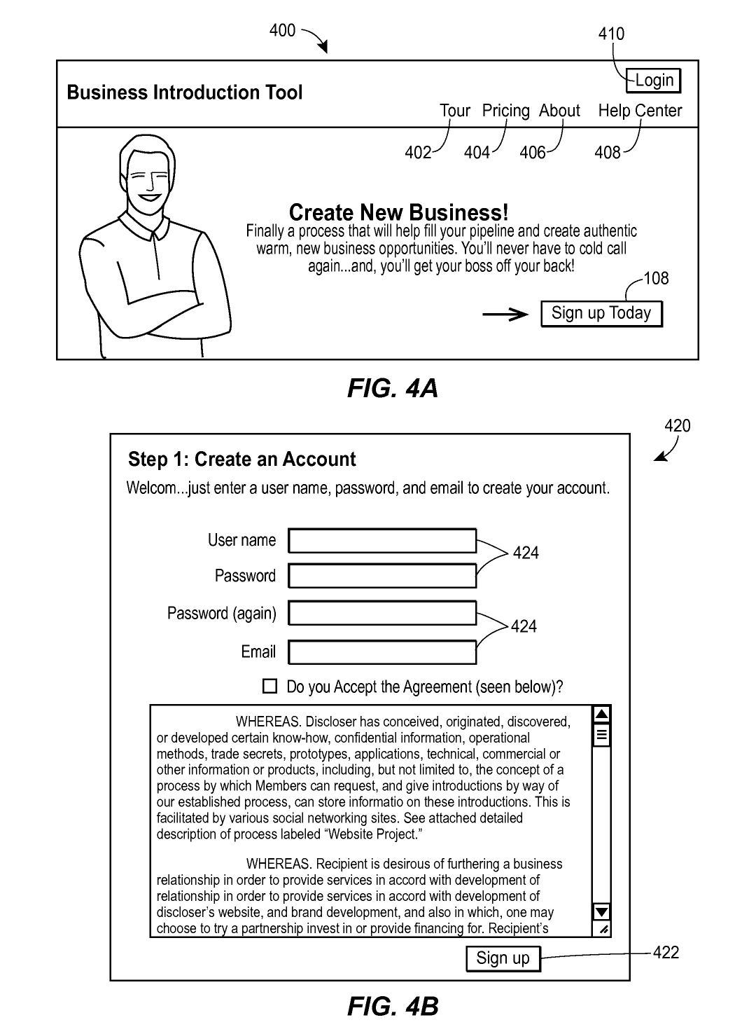

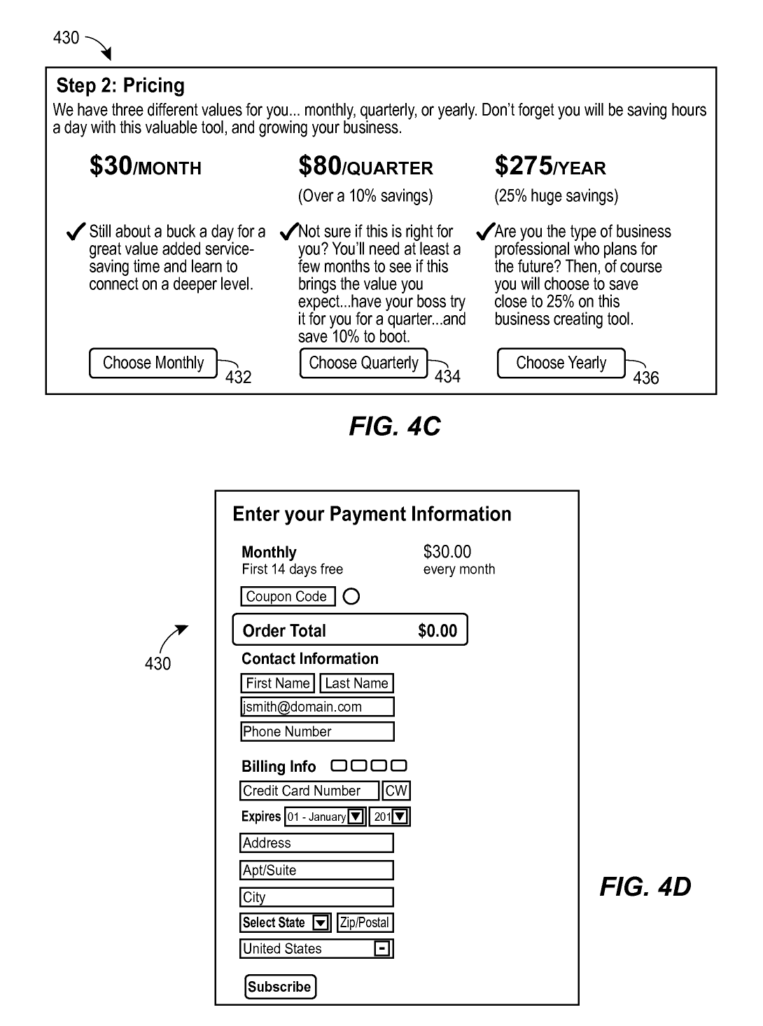

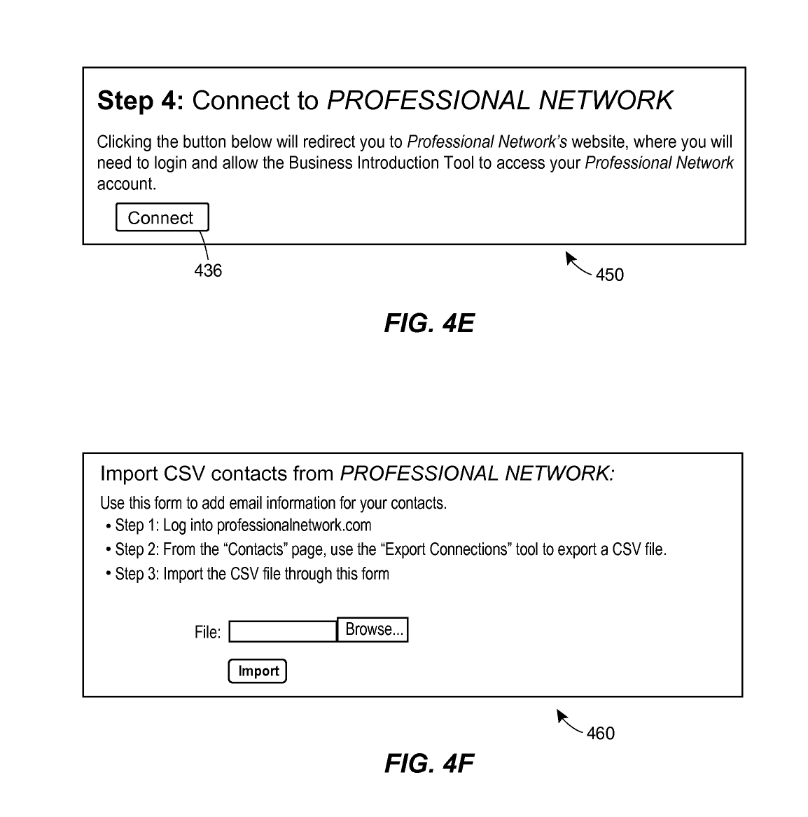

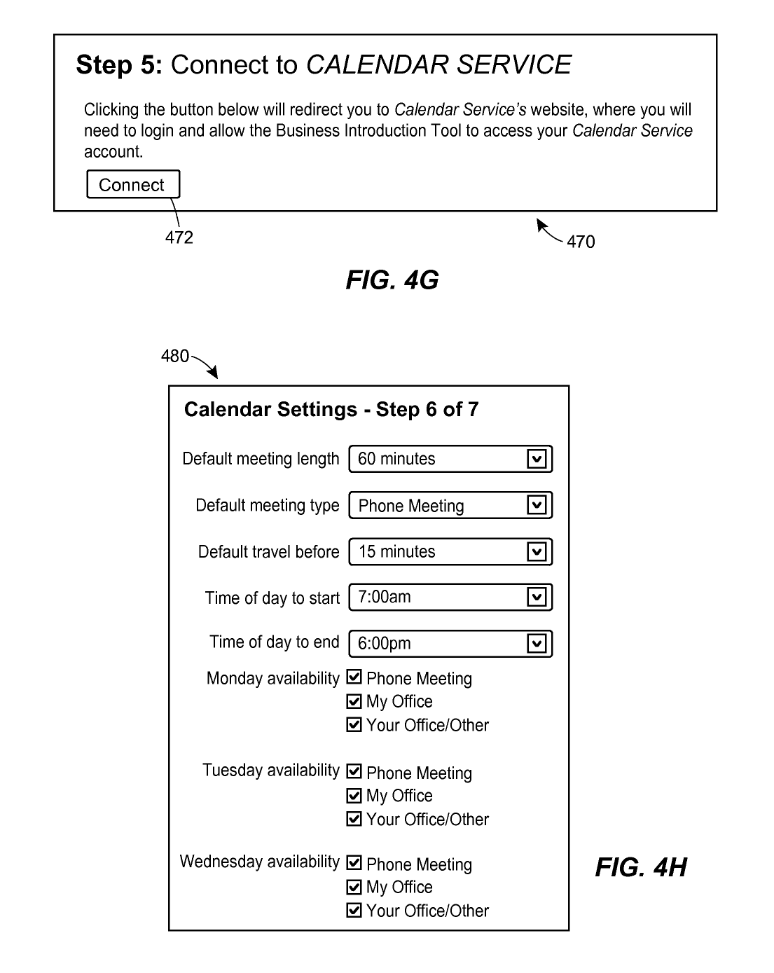

FIG. 3 is a flow diagram of an example method 300 for generating a user profile upon user subscription to a business introduction tool. The method 300 may be implemented by the business introduction server 108, for example. To aid in the description of the method 300, screenshots of example web pages, to be displayed on an end user device, are illustrated in FIGS. 4A-4I and will be referred to below. However, it is understood that the method 300 may utilize any suitable sort of interface, communication protocol, and/or web content allowing communication between an end user device and a business introduction server.

To begin, user identification information is received from an end user device, such as the end user device 102 (block 302). In one scenario, the business introduction server 108 may receive user identification information from a user via a web browser application accessing a business introduction tool. For example, a user may access, via a web browser executed on the end user device 102, an example landing page 400 of a business introduction tool as illustrated in FIG. 4A. The example landing page 400 may include various artwork, descriptions, summaries, etc. along with various selectable icons (e.g., selectable with a tap on a touchscreen or a click of a mouse). The selectable icons may include, for example: (i) a tour icon 402 which when selected will cause the display of key features of the business introduction tool; (ii) a pricing icon 404 which when selected will cause the display of pricing schemes for using the business introduction tool; (iii) an about icon 406 which when selected will cause the display of general information about the company and/or tool; (iv) a help center icon 408 which when selected will cause the display of technical support information; and (v) a login button 410 which when selected will prompt the user for authentication information (e.g., a username and password for returning customers).

Further, the landing page 400 may include a sign up button 422, in an implementation. Upon selecting the sign up button 422, in the scenario, a user may be presented with a form 420, as illustrated in FIG. 4B, allowing the user to enter user identification information. The user identification information may include, by way of example, username, password, email address, acceptance of one or more agreements, etc. Upon entering some or all of the information, a user may select a signup button 422 to send the user identification information from the end user device 102 to the business introduction server 108 where the information is received according to a suitable protocol, in the scenario.

In some cases, the business introduction server 108 may require the receipt of certain information before continuing the flow of method 300. For example, the business introduction server 108 may require all of the example form fields 424 (e.g., prompting the user for username, password, etc.) be complete before activating the signup button 422. Further, if portions of required information are missing from the received user identification information, the corresponding fields displayed on a web form, such as the form 420 may be highlighted (e.g., by color, alert messages, etc.), in an implementation.

Returning to FIG. 3, the user, for which corresponding user identification information has been received, is prompted for additional subscription details (block 304). For example, the business introduction server 108 may send further forms, web pages, etc. informing the user of various subscription options such as price, functionality, privacy, etc. options. In response to the prompt, the business introduction server 108 may receive subscription details outlining the user's choice of options and/or functionality. Further, for options requiring periodic payments or other financial transactions, the user may be prompted for financial account (e.g., credit card) information, in an implementation.

In one example scenario, a business introduction tool may have three different pricing options for a new user. The pricing options may be presented to the user via an example pricing webpage 430 as illustrated in FIG. 4C. The example pricing webpage 430 includes three selectable pricing options 432, 434, and 436 corresponding to a monthly, quarterly, and yearly subscription rate, respectively, for the business introduction tool. Upon receiving an indication that the user has selected one of the pricing options 432, 434, or 436, the business introduction server 108 may prompt the user for payment information, in the example scenario. For example, the user may be presented with a payment form 440 upon selection of the pricing option 432. The user may complete the payment form 440 within a web browser and communicate the corresponding payment information (e.g., credit card number, address, phone number, etc.) to the business introduction server 108, in an implementation.

Next, a user is prompted to grant the business introduction tool access to a professional network (block 308). For example, the business introduction server 108 may prompt a user of the end user device 102 to grant the business introduction server 108 access to the user's professional network account (e.g., maintained by the professional network server 116). In some cases, the end user device 102 may communicate authorization credentials (e.g., username and password) directly to the business introduction server 108, but, in other cases, the business introduction server 108 may redirect a user from the business introduction tool to web content generated and communicated by the professional network server 116.

In an example scenario, the user may be presented with an example connection page 450 as illustrated in FIG. 4E. On the connection page 450 a user is presented with information describing a necessary authorization of access (for the business introduction tool) to an example Professional Network. Upon clicking on the connect button 452, a user may be redirected (e.g., within a web browser) to one or more web pages of the Professional Network in which the user may authorize access for the business introduction tool.

It is understood that the Professional Network, to which a business introduction tool is granted access, may be any suitable professional network, customer relationship management system, or social media site. By way of example and without limitation, the business introduction tool may be granted access to a user account on Facebook®, Salesforce®, Yammer™, LinkedIn® professional networking services, Plaxo Network™, etc. In general, the example Professional Network may include any public, proprietary, or enterprise professional networking site or social media site which maintains a listing of professional or personal contacts and organizes connections between individuals (e.g., by industry, location, job title, etc.).

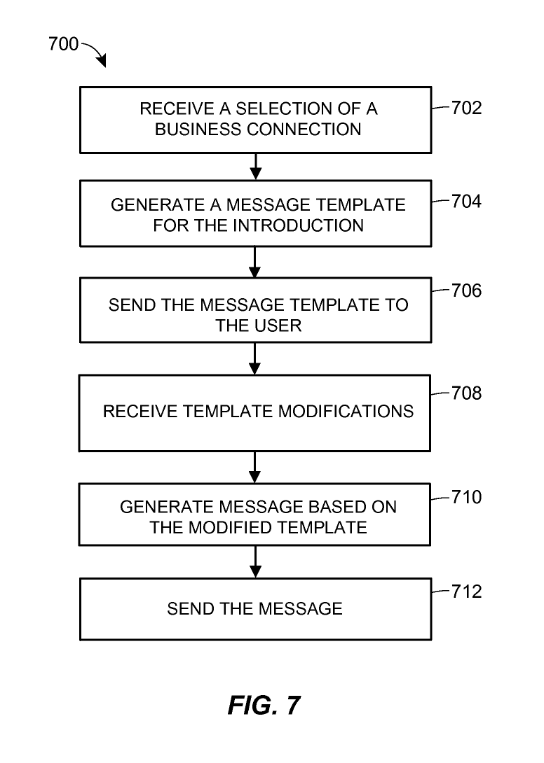

In some implementations, the business introduction tool (e.g., operated by the business introduction server 108) may also prompt a user to import (e.g., upload to the business introduction server 108 from the end user device 102) contacts. For example, the business introduction server 108 may prompt a user of the business introduction tool to import a Comma Separate Values (CSV) files of contacts from the example Professional Network, to which the business introduction server 108 has been granted access. In one implementation, such a prompt may include the example import contacts page 460 as illustrated in FIG. 4F. By way of example, the imported contacts may include names, email addresses, phone numbers, physical addresses, employer names, employer phone numbers, etc. As discussed with reference to FIG. 7, such contact information may be inserted into email or other message templates.

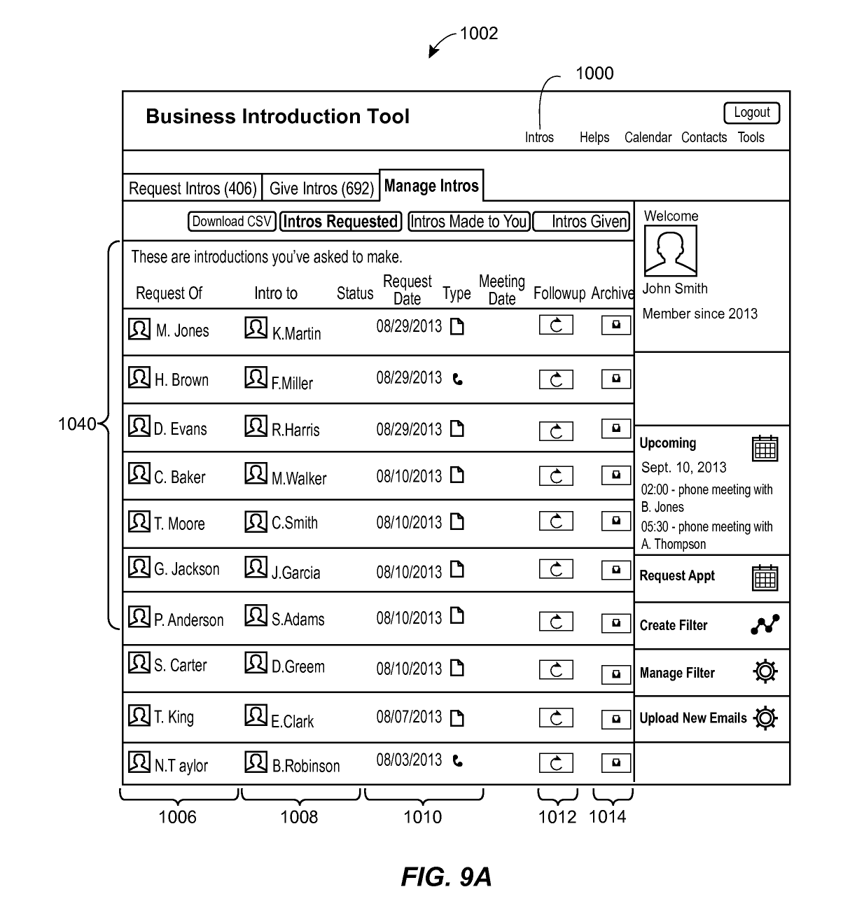

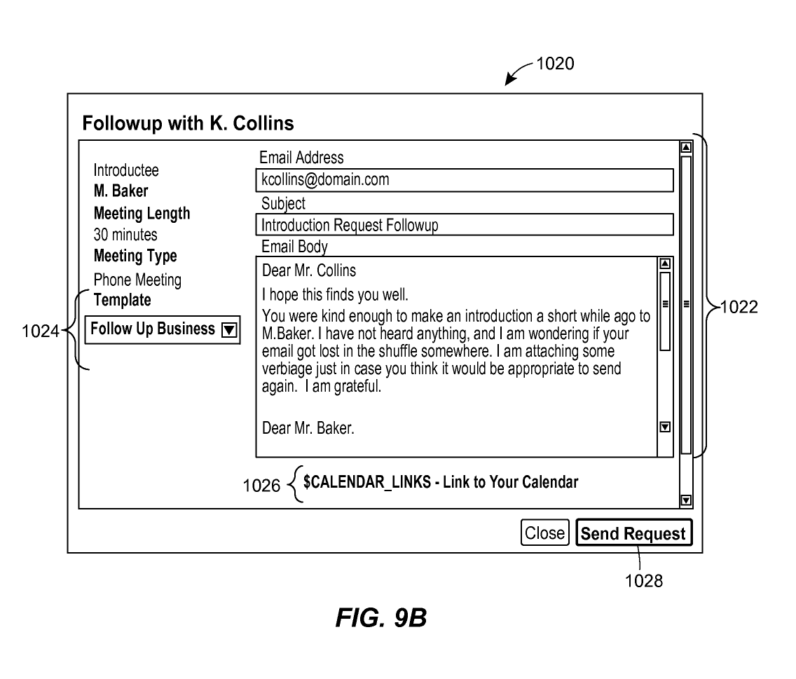

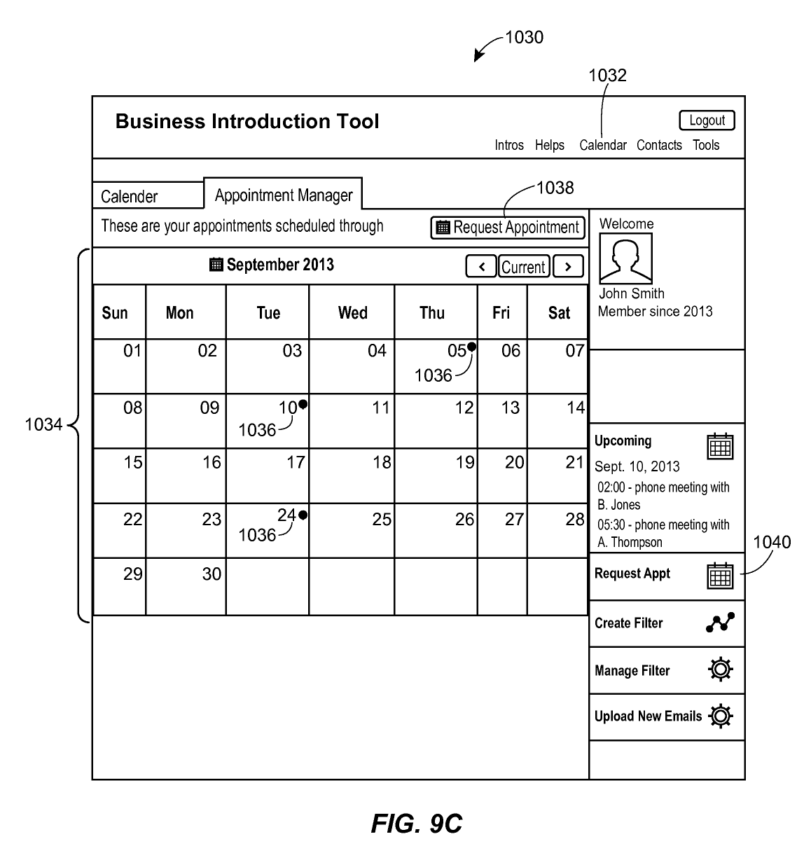

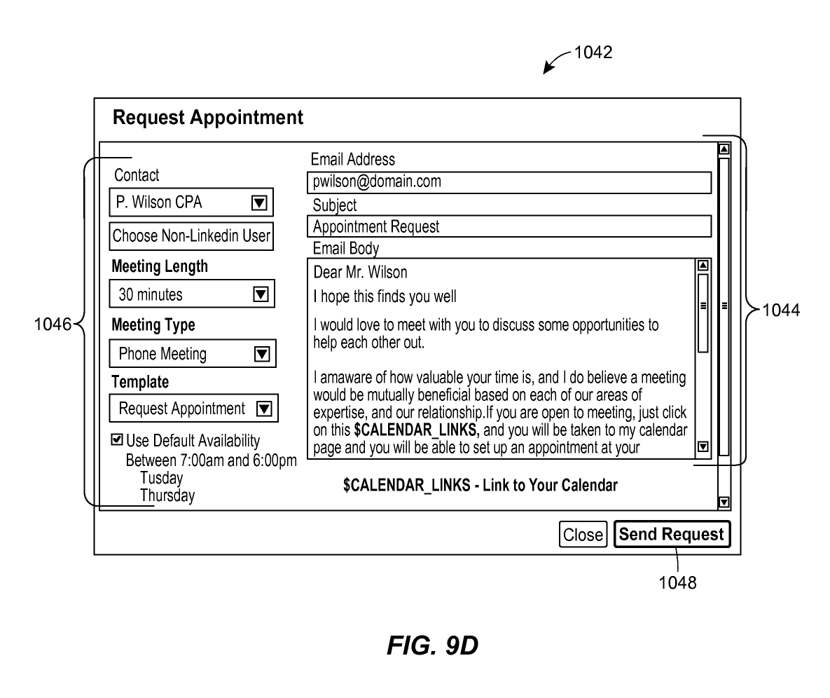

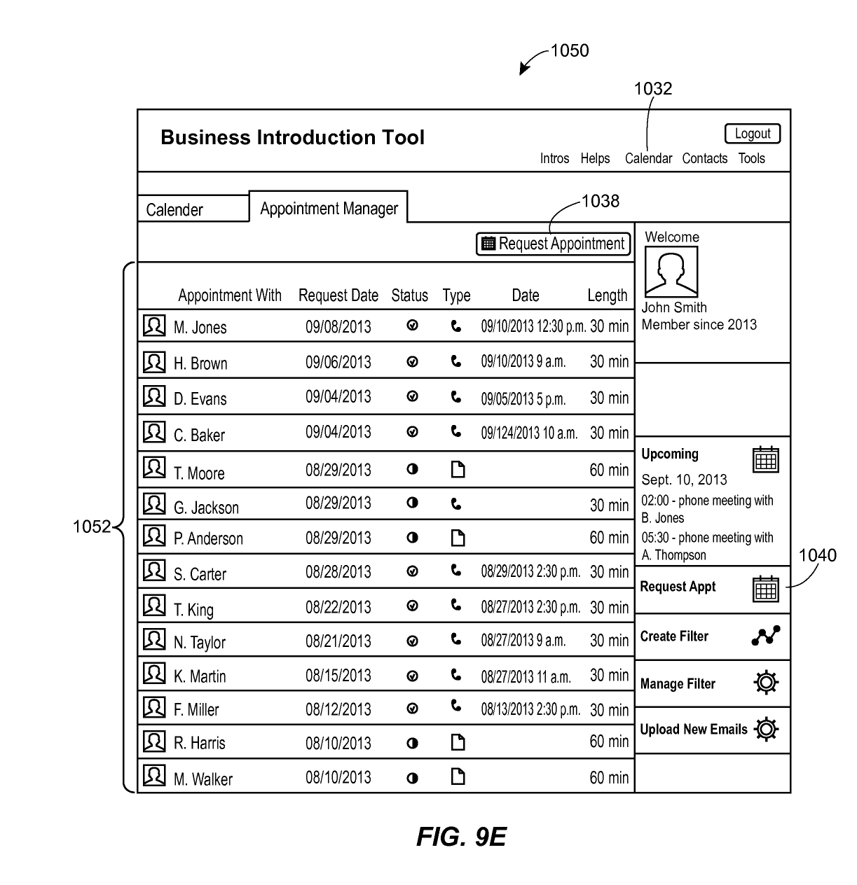

Still further, the business introduction server 108 may prompt a user to grant access to a calendar application or service corresponding to the user. For example, the business introduction server 108 may prompt a user of the business introduction tool to grant access to an online calendaring service account corresponding to the user via the calendar connection page 470. Similar to the connection page 450, a selection of the connect button 472 may redirect (within a web browser) the user to web pages of an example Calendar Service. Using these web pages a user may grant the business introduction tool access to the example Calendar Service. As will be discussed with reference to FIG. 9C, such access to a calendaring service may facilitate the organization and tracking of appointments. By way of example, the Calendar Service may include Google Calendar™, iCal®, Zoho®, etc.

Once access is granted to the example Calendar Service, the business introduction server 108 may prompt the user for preferred calendar options, in some implementations. In one scenario, a user may be presented with the example calendar options page 480 as illustrated in FIG. 4H. For example, the calendar options page 480 may allow a user to indicate preferred calendar settings such as default meeting lengths (e.g., 60 minutes), types (e.g., phone, in-person meeting, video conference, etc.), travel requirements (e.g., 15 minutes or 5 miles), meeting start/end times, and available options for each day of the week. These preferences are communicated to the business introduction server 108 for association with the user completing the subscription.

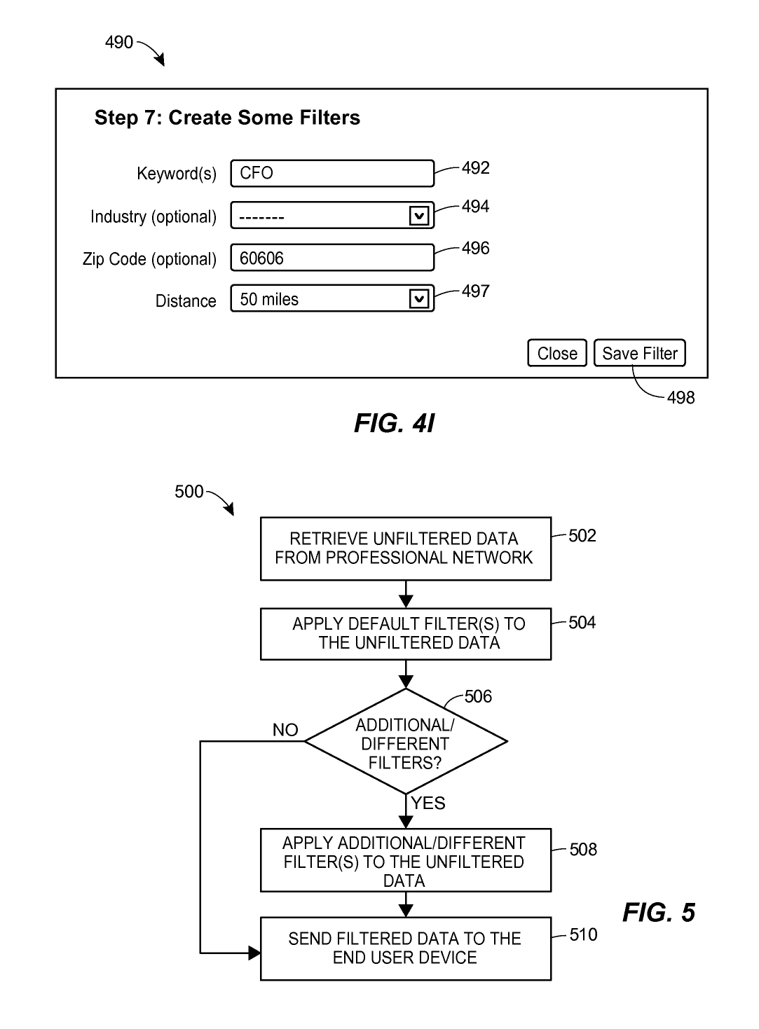

Returning to FIG. 3, the user is then prompted to create one or more filters to filter data (e.g., contacts) from a professional network (block 312). For example, a user accessing the business introduction tool via a web browser may be presented with the example filter page 490 illustrated in FIG. 4I. As discussed further with reference to FIG. 5, filters, such as those created using the example filter page 490 allow a user to efficiently and effectively identify high potential business contacts based on unfiltered data generated by a professional network. In some implementations, a user may create a filter by selecting or entering a keyword 492 (e.g., CEO, CFO, Attorney, etc.), an industry (e.g., Petroleum, Enterprise Software, etc.), a zip code, and a distance from the zip code (e.g., 50 miles). By saving a filter with the save filter button 498, a user may have access to the saved filter when using the business introduction tool to request or make introductions, as discussed further with reference to FIG. 7. Upon receiving a request to save a filter, filter details (e.g., keywords, locations, etc.) are received by the business introduction server 108 (block 314), in an implementation.

Next, user profile data, user filter data, and user preference data is stored in a database (block 316). For example, the business introduction server 108 may store: (i) user identification information, subscription details, and professional network details (e.g., received from the end user device 102 at blocks 302, 306, 310) in the user database 112 as part of the profile data 120; (ii) user saved filters (e.g., keywords, locations, titles, etc.) in the user database 112 as part of the filter data 122; and (iv) user preferences (e.g., calendar preferences) in the user database 112 as part of the preference data 124.

### Filtering Business Connections

FIG. 5 is a flow diagram of an example method 500 for filtering data retrieved from a professional network. The method 500 may be implemented by the business introductions server 108, for example, and a connection with a professional network may be established using method 300, for example.

To begin, unfiltered data is retrieved from a professional network (block 502). For example, the business introduction server 108 may retrieve data corresponding to a user (e.g., subscribed to the business introduction tool via method 300) from the unfiltered database 118. In some cases, this retrieval includes generating a request or query (e.g., including authentication information) communicated to a server maintaining the professional network, such as the professional network server 116. The retrieved data may include all or part of the data stored in the unfiltered database 118 and corresponding to the subscribed user, in an implementation. By way of example, the retrieved data may include a list of direct contacts (e.g., those business professional with whom the subscribed user maintains a direct connection), a list of connections (e.g., those business professional with whom the subscribed user is connected via the direct contacts), information about the contacts and connections (e.g., job title, location, previous job history, current job status, etc.), etc.

Next (block 504), any default filter(s) are applied to the unfiltered data. For example, a default filter may be specified (e.g., via user interaction during subscription) in the preference data 124. In this case, the business introduction server 108 may execute a routine, such as the filter routine 162 to eliminate, manipulate, or otherwise transform the retrieved unfiltered data. Using the keywords, locations, job titles, industries, etc. of a saved filter, the business introduction server may, by way of example, generate a list of connections matching the saved filter. In some implementations, the business introduction server 108 may filter only connection data corresponding to 1^{st} connections (i.e., connected through a contact), 2^{nd} connections (i.e., connected through a contact and a another individual), and/or any other level of connection. In this way, a user of the business introduction tool may target potential sales leads, business partners, etc. with whom they share a common contact, for example.

It is then determined if one or more additional/different filters should be applied to the unfiltered data (block 506). For example, in addition to or in substitution of a default filter, a user may select or indicate (e.g., within a web browser application) that another filter should be applied to the unfiltered data. In such a case, the business introduction server 108 may apply the new filter to the default filtered data and/or to the unfiltered data. If such an addition/different filter is indicated, the flow continues to block 508 where the addition/different filter is applied to either the default filtered or unfiltered data. However, if no such addition/different filter is indicated, the flow continues to block 510.

Next (block 510), the filtered data is send to the subscribed user. For example, the filtered data may be sent to a user of the end user device 102 in the form of one or more web pages constructed according to or along with the tool content data 128. The business introduction server 108 may send the filtered data to the end user device 102 according to any suitable protocol, in an implementation. For example, the business introduction server 108 may send the filtered data to the end user device 102 via a Hypertext Transfer Protocol (HTTP) message and/or a dedicated protocol for use with the business introduction tool and professional network.

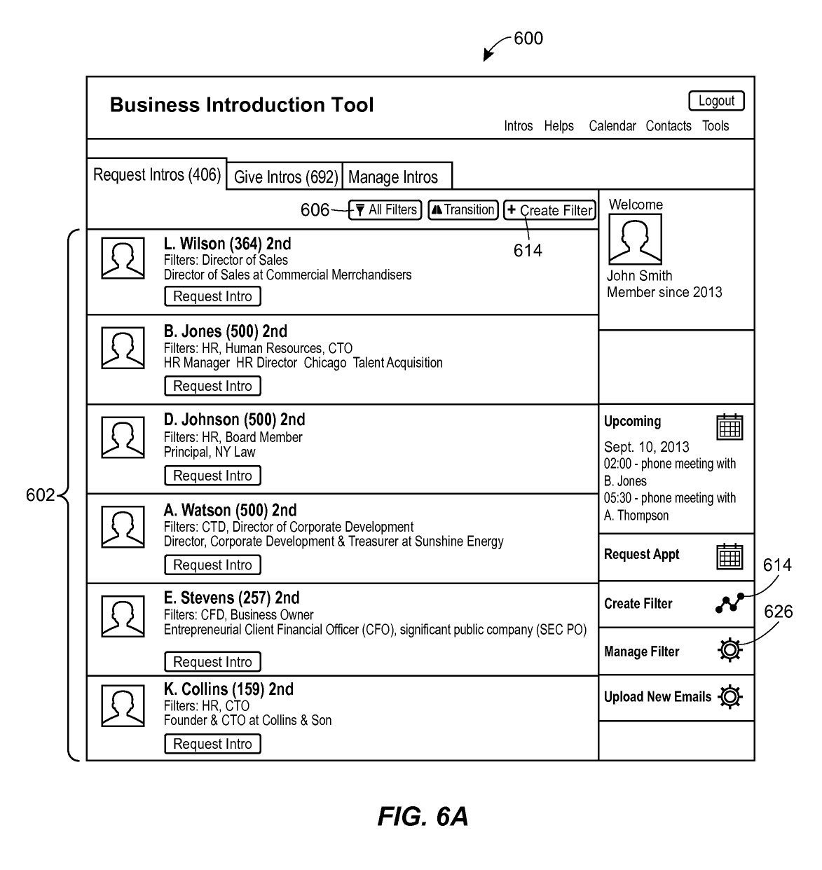

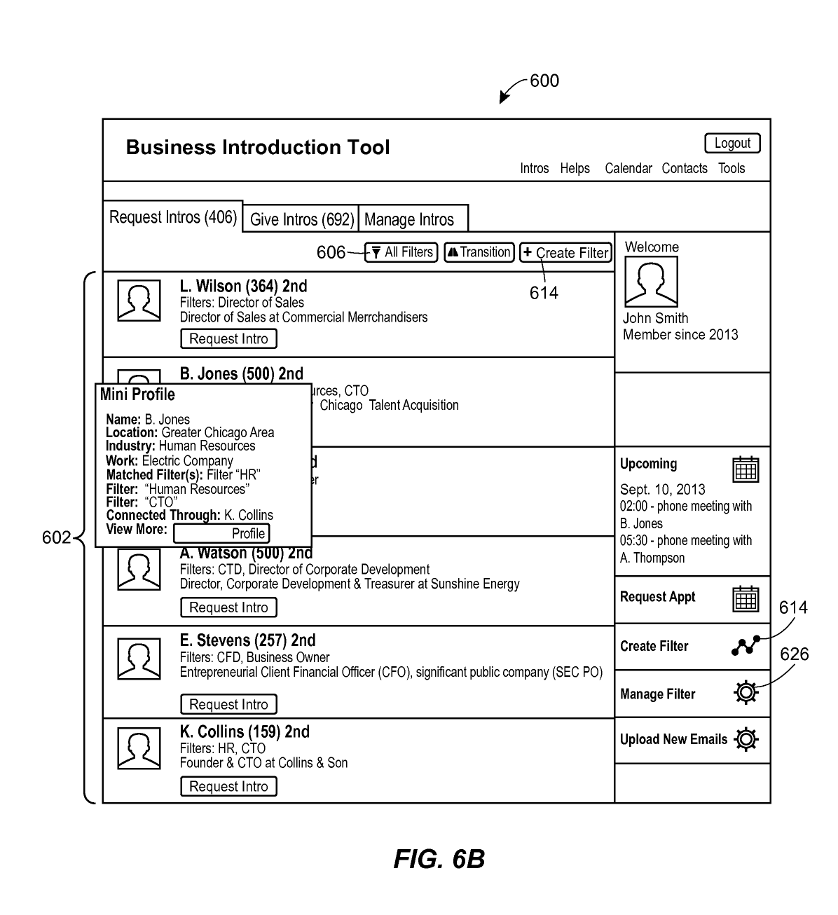

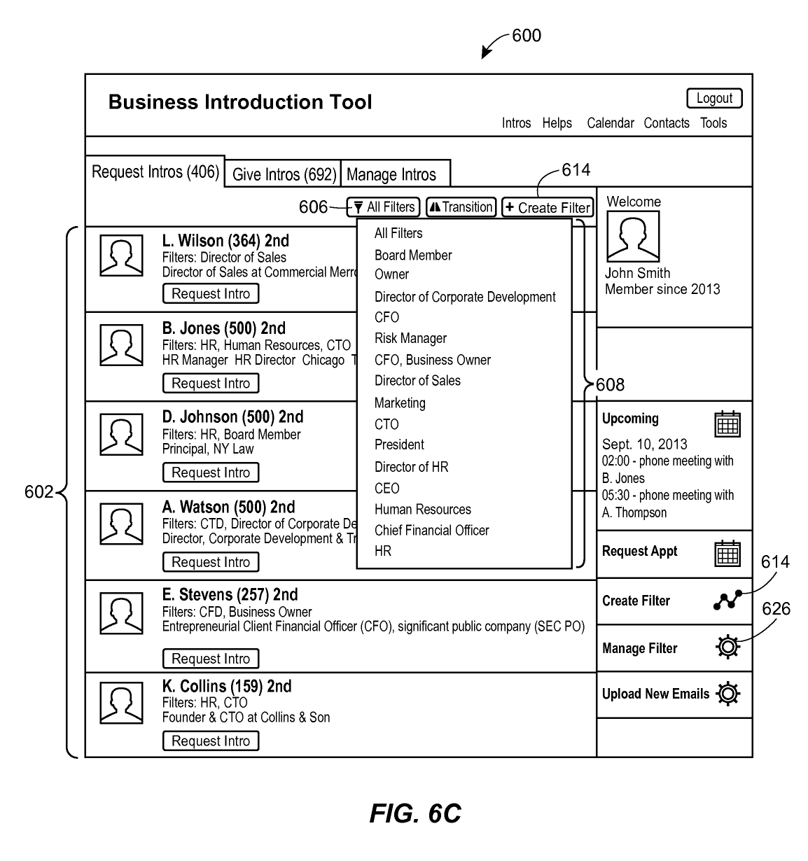

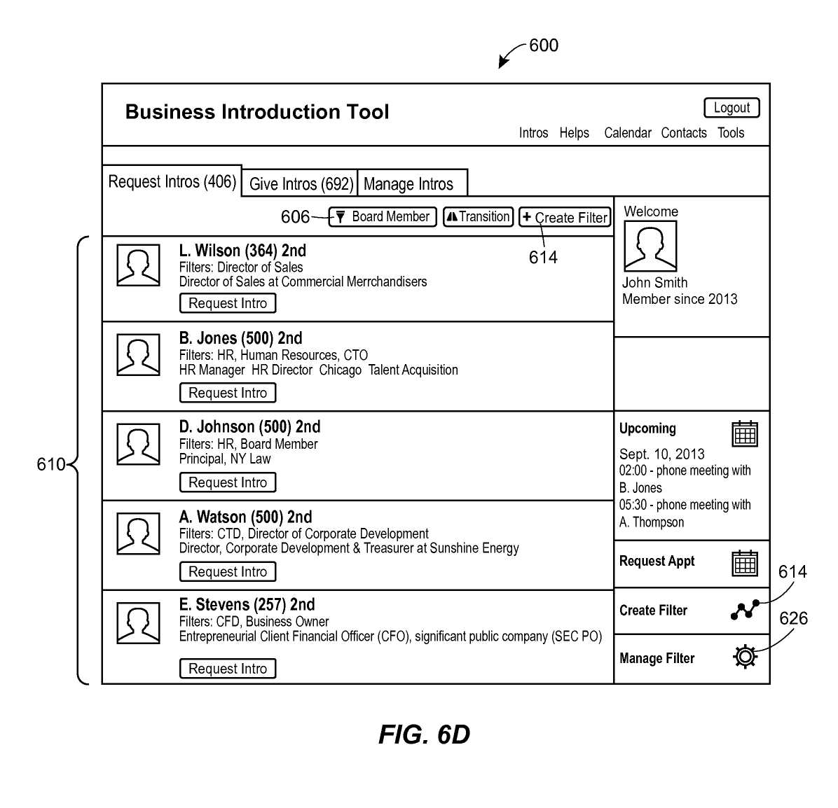

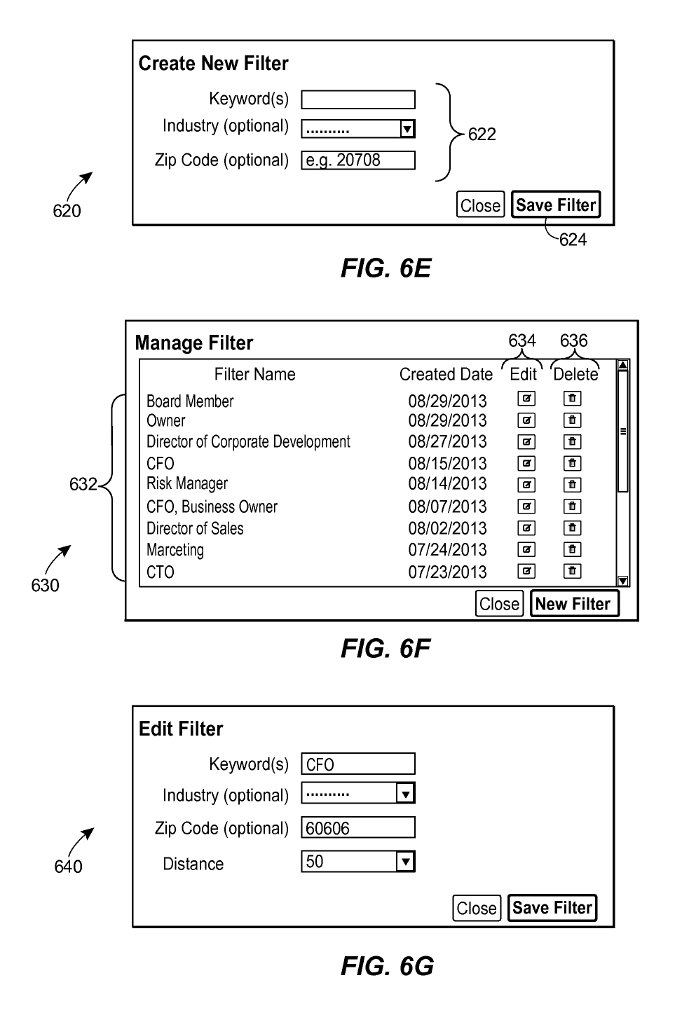

To further illustrate the example filtering of method 500, FIGS. 6A-6G illustrate example screenshots of web pages sent a user from a business introduction server for display within a web browsing application. For example, content for the web pages illustrated in FIGS. 6A-6G may be generated by the business introduction server 108 with filtered data from the professional network server 116 and tool content from the service database 114.

FIG. 6A illustrates an example landing page 600 which may be displayed in a web browser executing on an end user device upon “opening” (i.e., accessing through the web browser) the business introduction tool and logging into the tool (e.g., with a username and password). The landing page may include, in some implementations, a listing of connections 602 which have been filtered according to a default filter or which are unfiltered. In this case, the listing of connections includes only 2^{nd} connections (i.e., those individual connected to the user through the user's contacts, as indicated by data from a professional network).

Each of the connections in the listing of connections 602 includes a name, job title, picture, geographic location, etc., in an implementation. However, in general, a listing of connections may include any appropriate amount of information derived from professional network data and may be arranged in any suitable format, such as a table format, thumbnail format, icon format, etc. Further, upon “hovering” over one of the connections in the list of connections 602, the landing page 600 may activate an expanded window of information about the respective connection, in an implementation. One such expanded window 604 is illustrated in FIG. 6B.

The landing page 600 may further include a filters icon 606 with which a user may select (e.g., with a click or tap) an additional/different filter to be applied to the list of connections 602. In some cases, the filters icon 606 may be an expandable icon which when selected expands to show a list a saved filtered 608 corresponding to the subscribed user's account, as illustrated in FIG. 6C. From the listing of saved filters 608, a user may select the “Board Member” filter, in an example scenario. Subsequently, the business introduction server 108 may apply the “Board Member” filter to the list of connections 602 such that a filtered list of connections 610 (e.g., containing only board members) is generated and displayed on the landing page 600, as illustrated in FIG. 6D. In some cases, the filter icon 606 may also be modified to indicate a specific active filter 612 (e.g., “Board Member”).

In this way, users of the business introduction tool may quickly and efficiently locate desired or high potential connections. Further, a user may “hover” over or click one of the located connections to learn more about that connection and/or visit one or more professional networking sites about that connection, in an implementation. For example, a user may select the name or picture of one of the connections in the list of filtered connections 610 to be redirected to professional networking web pages about the selected connection.

If a user wishes to create a new filter, a user may select one or more create filter icons 614 on the landing page 600. In some implementations, upon selecting the create filter icon 614 the web browsing application may display a create filter window 620 in which a user may generate and/or save a new filter to filter data from the professional network, as illustrated in FIG. 6E. For example, the create filter window 620 may include one or more form fields 622 in which users may enter or select keywords, industries, and zip codes. In some implementations, the create filter icon 614 may be used to generate a “one time only” filter for filtering the list of connections 602, and, in other implementations, the user may select a save filter button 624 to save a filter to the list of filters 608.

Further, a user of the business introduction tool may select a manage filters tab 626 from the landing page 600 to view and/or edit all currently saved filters, in an implementation. For example, when a user selects the manage filters tab 626, a web browser may display a manage filters window 630 (e.g., as a pop-up window), as illustrated in FIG. 6G. The example manage filters window 630 includes a list of saved filters 632 with each saved filter having a corresponding edit icon 634 and delete icon 636. Selection of one of the delete icons 636 may remove the corresponding filter from the list of saved filters 632 and list of filters 608, and selection of one of the edit icons 634 may trigger the display of an edit filter window 640, as displayed in FIG. 6G, in which a user may edit and subsequently save the corresponding filter.

### Business Introductions

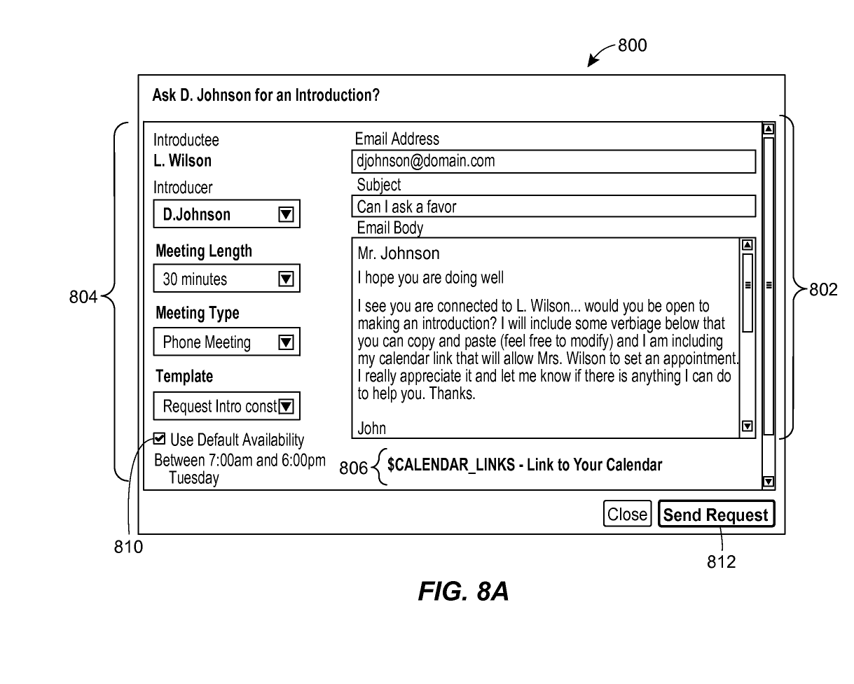

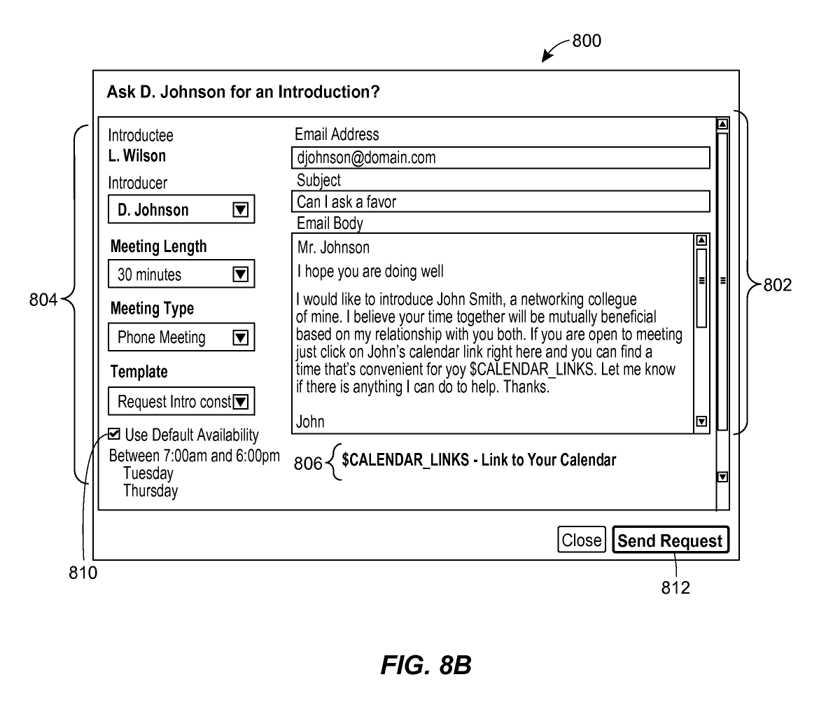

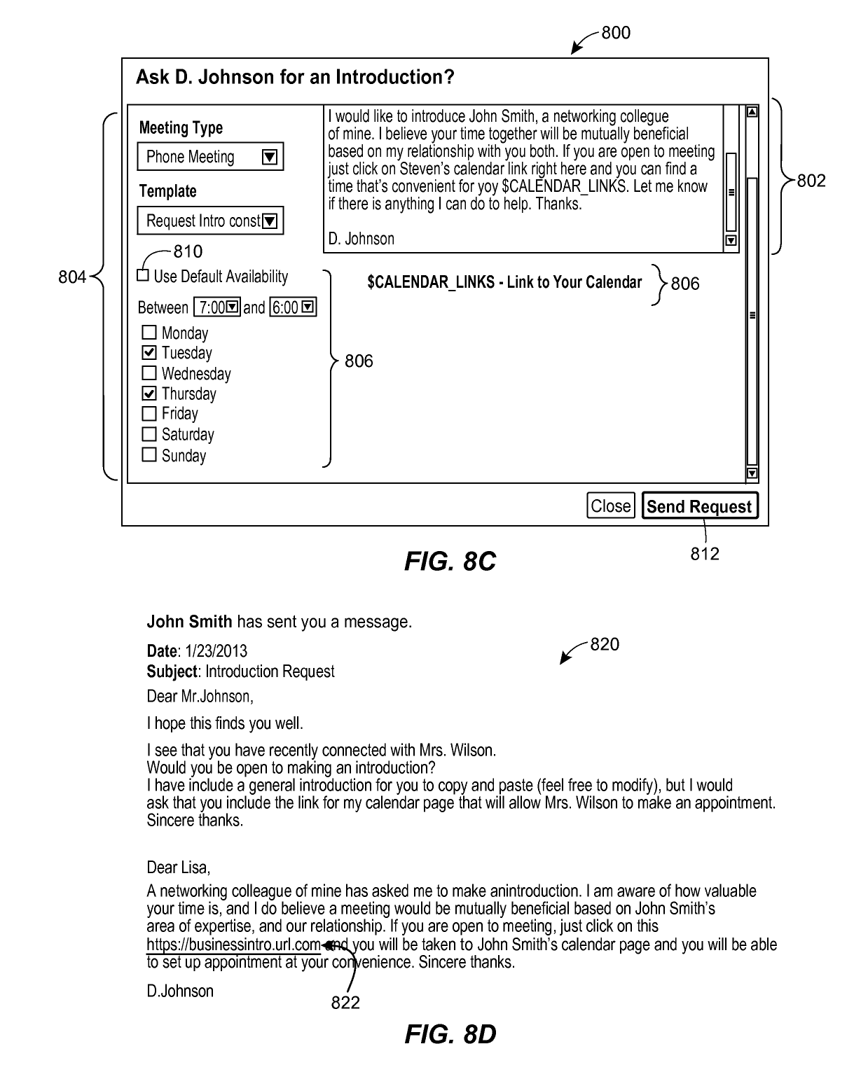

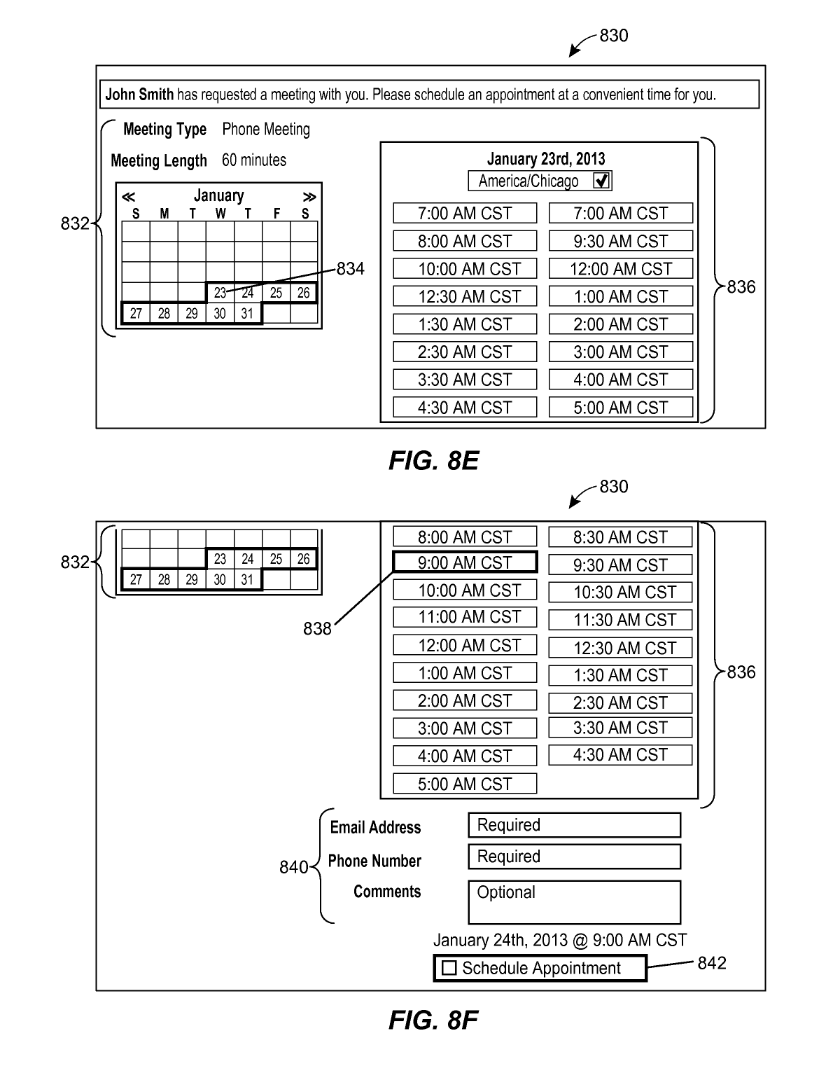

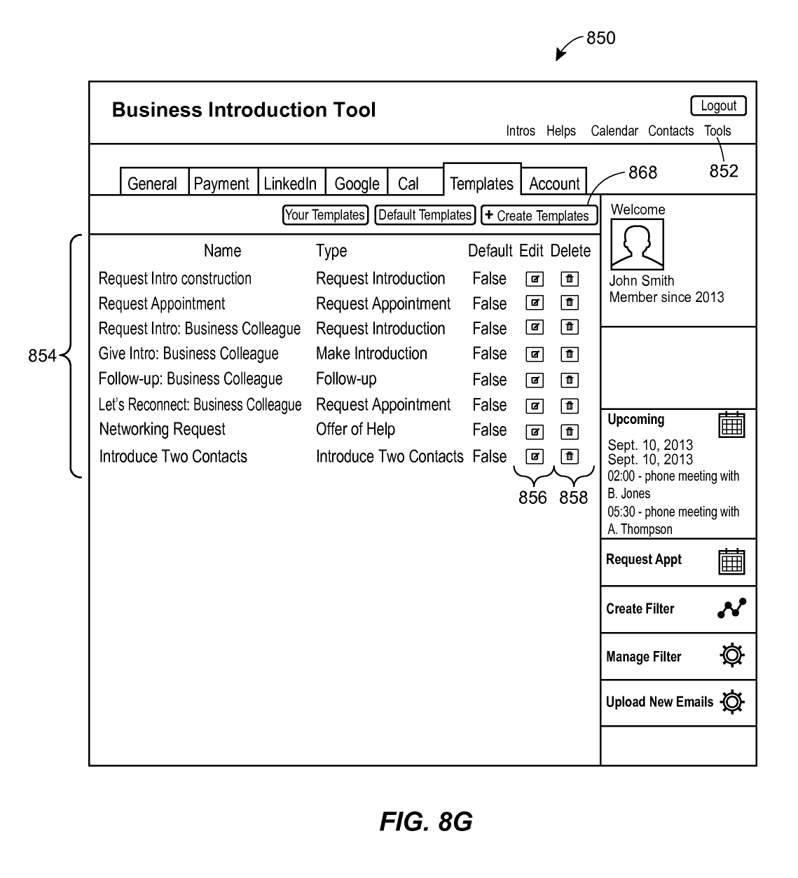

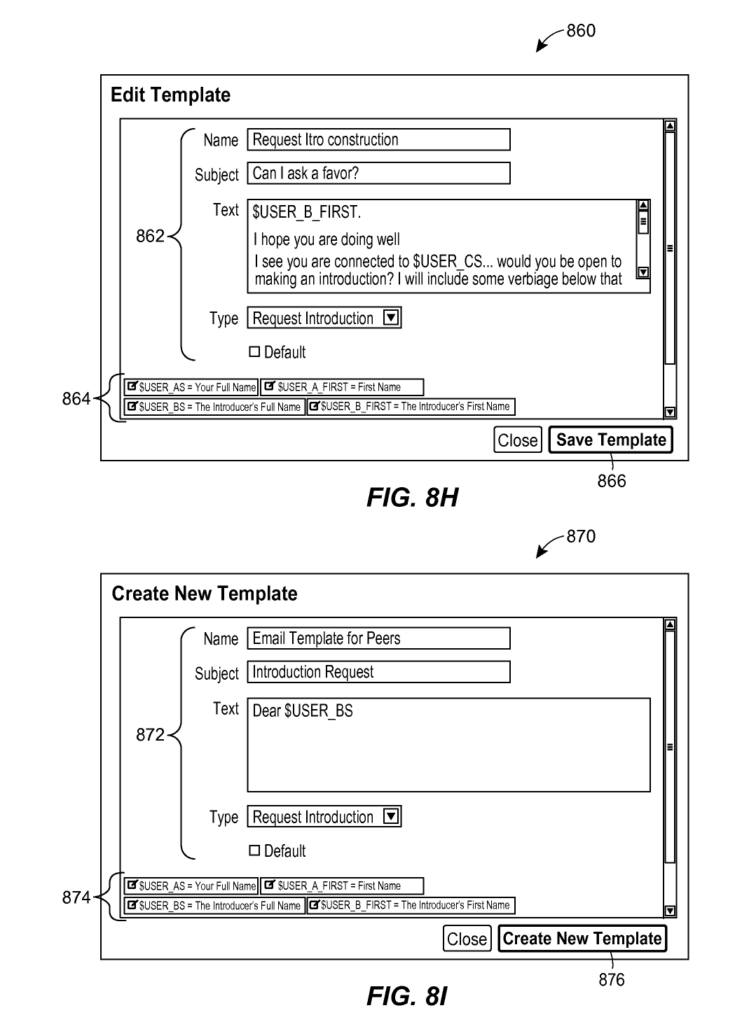

Filtering connections using data from a professional network may allow a user to efficiently locate high potential business connections. To further take advantage of this efficient filtering, the business introduction tool may facilitate the request of personal introductions (e.g., via email, phone, etc.) between a user of the business introduction tool and identified business connections. FIG. 7 is a flow diagram of an example method 700 for generating and managing business introductions. The method 700 may be implemented by the business introduction server 108, for example. To further clarify the method, example web page screenshots will be presented in FIGS. 8A-8I. However, it is understood that a business introduction server may generate and utilize any suitable web page content and/or other suitable electronic content formats, such as dedicated application content, to facilitate business introductions.

To begin, a selection of a business connection is received (block 702), where the business connection is a business professional to whom a user is connected via a contact. For example, a user may select a button or icon (e.g., such as a “Request Intro” button) corresponding to one of the connections displayed in a list of connections, such as the list of connections 602. Upon selection of the button or icon, an indication of the selected connection may be sent to and subsequently received by the business introductions server 108.

After receiving an indication of a selected business connection, a draft message is generated according to a template (block 704). In some implementations, the draft message may be an email, text, phone, or other message asking a contact to introduce the user to the selected business connection. For example, if a user is connected to the selected business connection “Susie Jones” through a contact “John Smith,” the business introduction server may generate a draft email message asking John Smith to introduce the user to Susie Jones. The draft message may be generated based on a default email template (e.g., stored in the templates 126), in an implementation, or a user created email template (e.g., stored in the preference data 124), in another implementation. By way of example, an email template may include generic text related to a business introduction and multiple substitutive variables used to insert a current date, contact/connection name, etc. User created templates are further discussed with reference to FIG. 8I.

The generated draft message is then sent to the user for review and/or modification (block 706). In one scenario, upon receiving a selection of a business connection, the business introduction server 108 may cause a message window 800, as illustrated in FIG. 8A, to be displayed in a web browser executing on end user device 102. The message window 800 may include a message interface 802 similar to that of an online email client and multiple message form fields 804 (e.g., drop down boxes, check boxes, etc.) used to customize the message. Within the message interface 802, a user may modify portions of the draft message, such as email addresses, subject lines, text in the body of an email, etc., for example. Further, the user may modify the contact's name, requested meeting parameters (length, time, format, etc.), availability, etc. with the form fields 804.

In one implementation, a user may scroll (e.g., with a click and drag) down the message window 800 to reveal further information. For example, referring to FIG. 8B, the message window 800 may include a variable listing 806 including information about the substitutive variables used in the message template. In one case, the message window 800 may indicate that a variable $CALENDAR_LINK$ is utilized to insert a link to a user's calendar. When the message is sent, the business introduction server will insert a current link in the message which, when opened in a web browser, will direct the recipient to the user's online calendar. Integration of calendars in the business integration tool will be further discussed with reference to FIG. 9C.

Further, some or all of the form fields 804 may be optionally expanded to reveal options outside of default options or preferred options, in some implementations. For example, as illustrated in FIG. 8C, a user may reveal further availability options 808 (i.e., options indicating a user's availability for a introduction meeting) by de-selecting a checkbox 810, whereas only default or preferred availability options are displayed when the checkbox 810 is selected.

Returning to FIG. 7, draft message modifications (e.g., those generated by user interaction with the messaging interface 802 and/or the form fields 804) are received (block 708). For example, a user may trigger the sending of a draft message modification to the business introduction server 108 by selecting the send request button 812. Then, using the modified draft message, an introduction message is generated (block 710). In an implementation, the business introduction server 108 may generate an email message according to the modified draft message and including substitutions for any substitutive variables. FIG. 8D includes an example email message 820 generated according to a modified draft email message. The email message includes at least one link 822 resulting from a substituted variable and modified text received via user interaction with a messaging interface, such as the messaging interface 802.

Although an example of an email introduction message is included in FIG. 8D, the business introduction tool of the present disclosure may utilize messages in any format. By way of example and without limitation, the business introduction tool may generate email, mobile text messaging, chat, phone, Voice over Internet Protocol (VoIP), image, video, etc. messages according to message templates and user directed template modifications.

Returning to FIG. 7, the introduction message may be sent to the recipient (block 712). For example, after generating the introduction message, the business introduction server 108 may send the email message 820 to the email address of the recipient (e.g., the user's contact). In some cases, the business introduction server 108 may access the email address of the recipient via an imported contacts list (e.g., see FIG. 4F), or the business introduction server 108 may receive the email address based on user interaction with the messaging interface 802. The business introduction server may send the message according to any suitable protocol, such as HTTP, over any suitable mobile or wide area network, such as the Internet.

Upon receiving the email message, the recipient may follow a link in the message to confirm and/or respond to the message. For example, a recipient may follow the link 822 to a web page 830 as illustrated in FIGS. 8E and 8F. The web page 830 may include: (i) a calendar interface 832 in which the recipient may select a particular day 834 for the requested introduction meeting; and (ii) a time interface 836 in which the recipient may select a particular time 838 for the introduction meeting. In some cases, dates and/or times preferred by the user (e.g., as previously indicated in the form fields 804) may be highlighted in the calendar interface 832 and the time interface 836. Further, in some other cases, the calendar interface 832 and the time interface 836 may only allow the recipient to select dates and/or times which are preferred date and/or times corresponding to the user.

The web page 830 may also include one or more form fields 840 and a schedule appointment button 842, in an implementation. The one or more form fields 842 may allow the recipient to provide contact information (e.g., an email address and phone number) and make text comments (e.g., “Can we meet at Joe's Coffee Shop”), for example. When the recipient selects the schedule appointment button 842, in some implementations, the content entered into the form fields 840 is sent to the user (e.g., using an email message) and/or an appointment with the recipient for the indicated date and time is added the user's calendar. Further discussion of a user calendar integrated with the business introduction tool is discussed with reference to FIG. 9C.

In some implementations, a user of the business introduction tool may manage, create, and edit message templates via a “tools” interface of the business introduction tool. FIG. 8G illustrates an example manage templates web page 850 in which email templates may be managed. The manage templates web page 850 may be accessed, for example, via a tools tab 852 also displayed on a landing page, such as the landing page 600, and includes a list of currently saved message templates 854. In some cases, a user may choose (e.g., via a drop down menu in the form fields 804) one of these saved templates when modifying/generating an introduction or other message. Similar to the manage filters window 630, the manage templates page also includes an edit icon 856 and a delete icon 858 for each of the templates in the list of currently saved message templates 854.

When one of the edit icons 856 is selected, a web browser may cause a message edit window 860, as illustrated in FIG. 8H, to open. The message edit window 860 may include a plurality of message form fields 862 in which a user may edit the message body, template name, subject line, etc., and the message edit window may include a plurality of selectable variable names 864 which when selected by the user insert a corresponding substitutive variable into the message template, in an implementation. By way of example, substitutive variables that may include variable representations of a links (e.g., to a calendar), dates, and names (e.g., recipient). By selecting (e.g., with a click or tap) a save template button 866, a user may save modifications to the template.

Further, the manage templates page 850 may include a create template icon 868 which, when selected by the user, opens a create template window 870, as illustrated in FIG. 8I. Similar to the edit template window 860, the create template window 870 includes a plurality of form fields 872 and a plurality of selectable variable names 874. In one case, the create template window 870 and edit template window 860 may include the same form fields and selectable variable names, but, in general, the creating and editing of templates may include any appropriate form fields, selectable variable names, and/or other user interfaces. When a user selects a create new template button 876, a template may be saved to the list of currently saved message templates 854 according to the user interaction with the plurality of form fields 872 and the plurality of selectable variable names 874.

Although the manage templates page 850 is emphasized above, the tools tab 852, or other suitable tools interface, may allow a user of the business introduction tool to manage a variety of settings. For example, the tools tab 852 may allow a user to manage or edit setting related to an integrated calendar, default appointment times, subscription pricing options, payment information, access to one or more professional networks, etc.

### Managing Introductions

In order to efficiently and effectively manage business introductions, the business introduction tool may utilize a plurality of user interfaces, such as web pages. For example, the business introduction server 108 may generate a variety of web pages according to the tool content data 128 and records of previously sent or drafted introduction messages. It is understood that these web pages for the management of business introductions may be displayed in a web browsing application (e.g., executed on the end user device 102), or similar content may be presented to a user via a dedicated application (e.g., an application executing on a mobile device such as a smartphone).

FIGS. 9A-9E illustrate example web pages, with content generated by a business introduction server, which a user can utilize to manage and organize business introductions. Using an intros tab 1000 on a landing page, such as the landing page 600, a user may access a manage intros page 1002 as illustrated in FIG. 9A, in an implementation. The example manage intros page 1002 includes a list of previously requested business introductions 1004 and a variety of options and information corresponding to those business introductions. In some implementations, when a business introduction request is sent to a contact (e.g., according to the method 700) an item corresponding to that request is added to the list of previously requested business introductions 1004.

In one example table format, the manage intros page 1002 includes: (i) a column of contact entries 1006 indicating contact to whom introduction requests have been sent; (ii) a column of connection entries 1008 indicating with whom the user has requested introductions; (iii) a column of meeting entries 1010 indicated requested meeting dates/times and meeting type; (iv) a column of follow up icons 1012; and (v) a column of archive icons 1014. Further, in some cases, the entries may be arranged vertically according to the date/time of introduction requests (e.g., most recent at the top to least recent at the bottom of the list of previously requested business introductions 1004).

In some implementations, the column of meeting entries 1010 may include a status (e.g., accepted, pending, etc.) for each of the introduction requests. In this way, a user of the business introduction tool may quickly visualize and understand what requests for business introductions have been sent recently and the status of each of those requests.

By selecting one of the follow up icons 1012, a web browser may present the user with a follow up window 1020, as illustrated in FIG. 9B. Similar to the message window 800, the follow up window 1020 includes a message interface 1022, one or more form fields 1024 for changing message options, and a listing of substitutive variables 1024 used in the message, for example. When a user selects the send request button 1028, a message (e.g., email message) may be sent to the contact corresponding to the respective request for introduction. In this manner, a user may remind a contact about the business introduction and increase the chance of a possible response from the corresponding connection, in some scenarios.

In addition to a manage introductions page, a user may manage introductions and meetings with one or more calendar or appointment based web pages. For example, FIG. 9C illustrates a calendar page 1030 accessible via a calendar tab 1032 on a landing page, such as the landing page 600. The example calendar page 1030 includes a calendar interface 1034 which can be displayed according to any format, such as a month, week, day, etc. format. Using the calendar interface 1034, a user may “scroll,” or otherwise navigate, through multiple months, weeks, days, etc. to visualize currently arranged business introductions (e.g., face-to-face meetings, phone calls, etc.). For example, a currently arranged business introduction may be indicated within the calendar interface 1034 by color highlighting (not shown), text descriptions (not shown), or with one or more indicative icons 1036.

Further, the calendar interface 1034 may be integrated with other calendaring services to which the user is subscribed, in an implementation. For example, a user may link the calendar interface 1034 to a Google Calendar™ account (e.g., using the example method 300), and the calendar interface 1034 may synchronize appointments with the Google Calendar™ account. In some implementations, the calendar interface 1034 indicates appointments added to a calendaring service account by the user (e.g., outside of the business introduction tool) and the calendaring service account indicates business introduction related appointments (e.g., made within the business introduction tool). In this manner, a user may experience a seamless transition between the calendar interface of the business introduction tool and an interface of one or more external calendaring services.

In some implementations, a user may request an appointment with a contact, connection, or other business professional directly from the calendaring application and/or landing page. For example, a user may select the request appointment icon 1038 or the request appoint tab 1040. Such a selection may, in some implementations, trigger the presentation of a request appointment window 1042 as illustrated in FIG. 9D. Similar to other message windows, such as the message window 800, a user may modify a message template with a message interface 1044 and select appointment options (e.g., type, date, time, etc.) via one or more form fields 1046, for example. In an implementation, a user may select the send request button 1048 to send the appointment request to the recipient. In some cases, a calendar interface will display the requested appointment as a tentative appointment (e.g., indicated via color or other highlighting) until acceptance of the appointment (e.g., via the recipient following an included link).

Still further, a user may manage and organize business introduction appointments via an appointment interface. FIG. 9E illustrates an appointment page 1050 also accessible via a calendar tab 1032 on a landing page, such as the landing page 600. In an implementation, the appointment page 1050 may include a list of appointments 1052, where the appointments may be any suitable type of appointments (e.g., requested, accepted, pending, tentative, etc.) and may be arranged according to appointment date/time. Further, each appointment entry in the list of appointments 1052 may include information about the appointment (length, type, request date, etc.) along with a current status of the appointment (e.g., accepted, new time proposed, tentative, etc.)

### Business Help Functionality

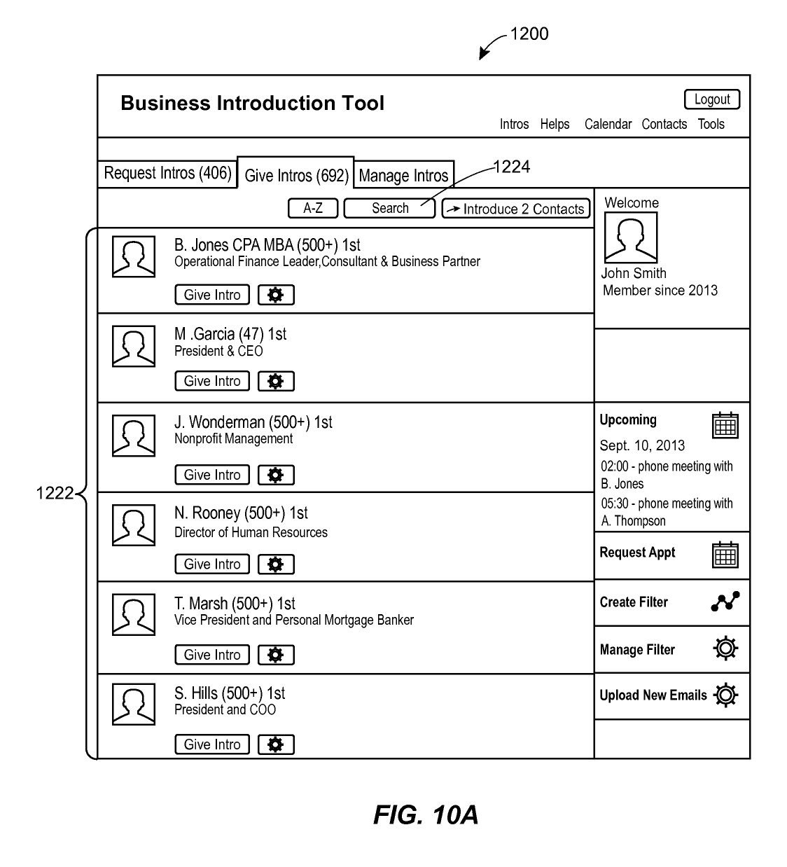

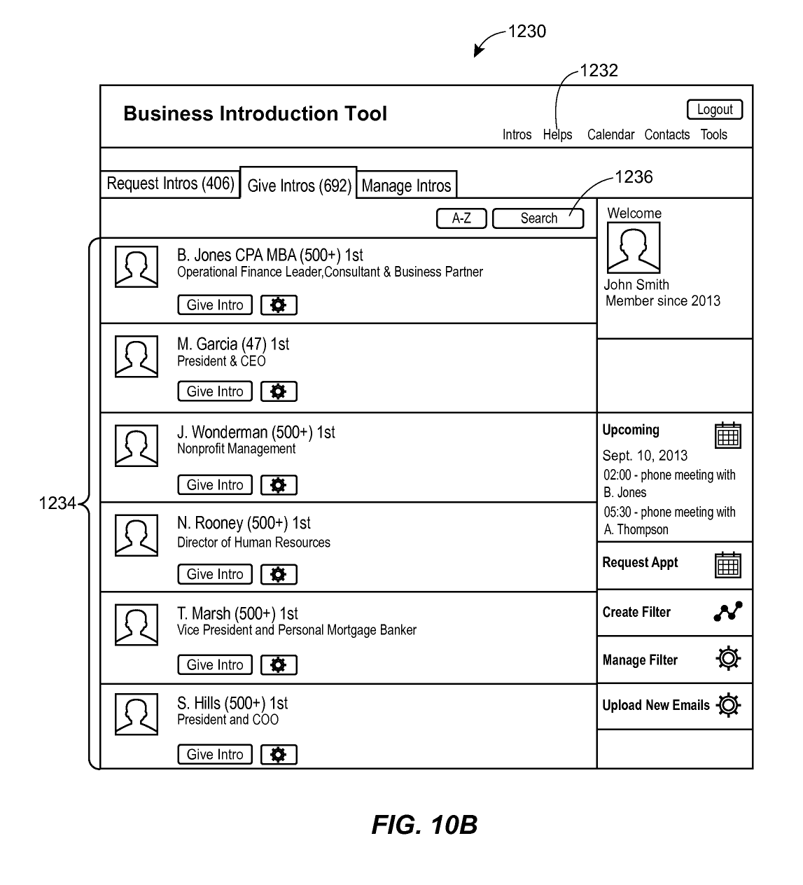

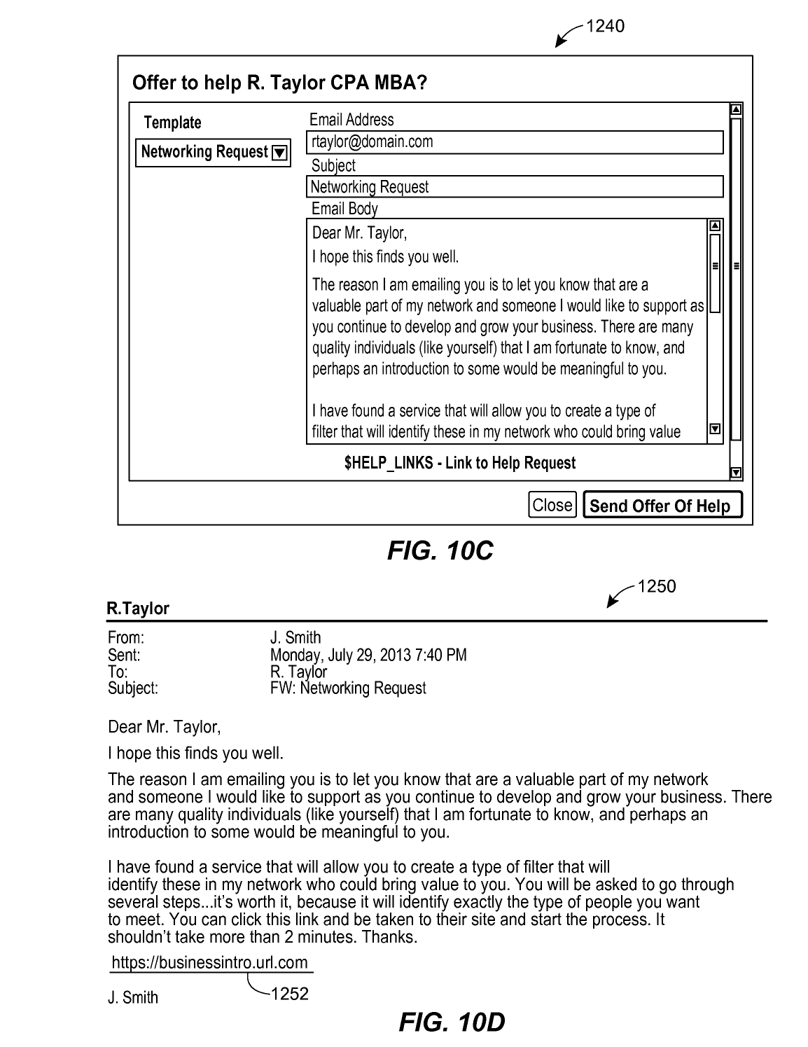

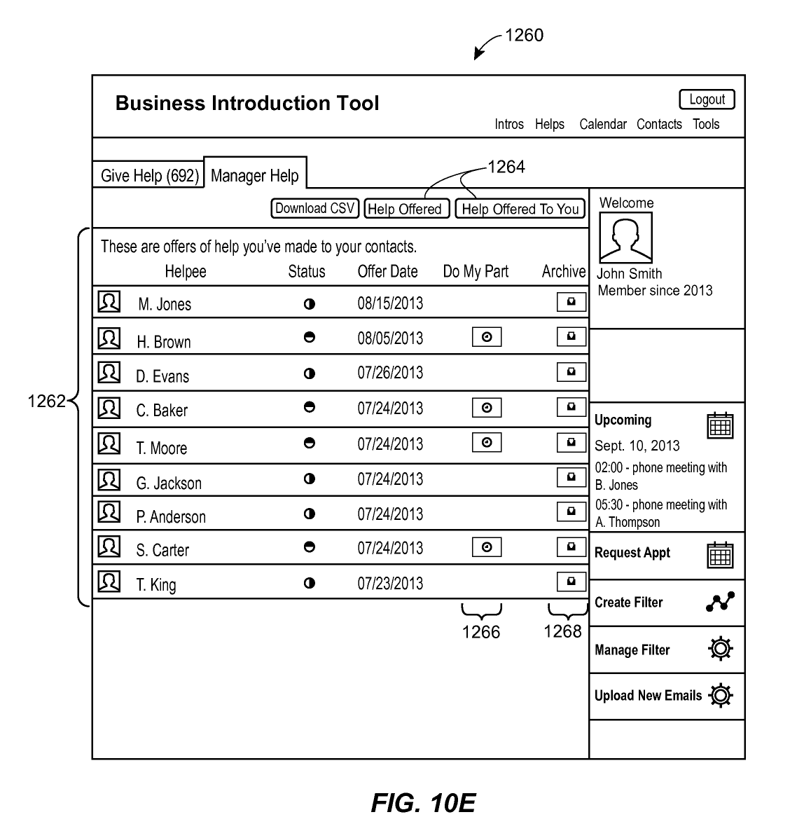

Although the business introduction tool of the present disclosure facilitates business introductions for a user, the tool may also allow a user to make business introductions for other users and/or provide help to other business professionals. FIGS. 10A-10E illustrate web pages, generated and managed by a business introduction server, that facilitate such introductions and/or help. However, it is understood that a business introduction server, such as business introduction server 108, may utilize any suitable web pages and/or application content to facilitate business introductions and/or help.

Along with a listing of connections, such as the listing of connections 602, an example landing page 1200 may allow a user to access a listing of direct contacts 1222. For example, the business introduction server 108 may generate the listing of direct contacts 1222 based on data from the professional network server 116 corresponding to the user. The user to “scroll” through the listing of direct contacts 1222, and the landing page 1200 may allow a user to search for one or more particular contacts via the search bar 1224, in an implementation. For example, a user may enter “John Smith” into the search bar (e.g., via a keyboard) to search for a particular contact with the name John Smith. However, it is understood that a listing of contacts may be made searchable with any suitable interface, such as a search box, one or more filter options, voice recognition, etc.

A user may select one of the contacts in the listing of connections 1222 by clicking or tapping on a button or name to indicate that the user would like to introduce the contact to another business professional, in an implementation. For example, such a selection may trigger a web browser to open a message window, similar to the message window 800, such that the user may introduce the selected contact via an email message. Further, the landing page 1200 may include an introduce two contacts icon 1226 allowing the user to select and introduce two of the contacts listed below in the listing of direct contacts 1222.

Although a user may utilize the business introduction tool to introduce two or more business professionals, a user may also utilize the business introduction tool to offer help to one or more contacts. Help may include, by way of example, making introductions, endorsing job candidates, providing business advice, etc., and an offer for help may allow the recipient to specify a type of help that is particularly relevant.

FIG. 10B illustrates an example business help page 1230 accessible to a user via a helps tab 1232 on a landing page, such as the landing page 600. The help page 1230 may including a listing of direct contacts 1234 and a search bar 1236 similar to that of the landing page 1200, in an implementation. However, when one of the listing of direct contacts 1234 is selected, a web browser may display an offer help window, such as the example offer help window 1240 illustrated in FIG. 10C. Using such an offer help window, a user may send a message, such as the example email message 1250, to the selected contact offering to provide business help.

In response to the offer for help, the recipient may follow a link 1252 in the received message. In some implementations, the link 1252 will redirect the recipient to a page in which the recipient can specify the type of help desired. In one example scenario, the recipient may follow the link 1252 to web pages generated by the business introduction server 108 which allow the recipient to specify one or more types of introductions desired by the recipient. For example, the recipient may create one or more filters (e.g., “CEOs of Enterprise Software Companies”) specifying types of business professionals for which the recipient desires an introduction. Subsequently, the business introduction server 108 may execute the recipient's filters on the user's contact to identify matching contacts, and the business introduction server 108 may inform the user of the matching contacts (e.g., with an email message or mobile alert).

In order to manage and organize offers for help and the subsequent responses, a user may access a manage help page 1260 (see FIG. 10E), in an implementation. Similar to the manage intros page 1002, the help page 1260 may include a list of contacts 1262, and a user may access the help page 1260 via the helps tab 1232 on a landing page. In some implementations, the list of contacts 1262 may include both contacts to whom help has been offered and contacts who have offered help to the user, and/or a user may switch between “help offered” and “help offered to you” views via one or more selectable icons 1264.

The manage help page 1260 may include a “do my part” column 1266 in which the user may follow selectable icons in order to provide help to contacts, in an implementation. For example, a user may follow one of the selectable icons in the do my part column 1266 in order to run a recipient specified filter on the user's contacts and introduce the recipient to business professionals matching the recipient specified filter. The manage help page 1260 may also include an archive column 1268 containing selectable icons which allow a user to remove items from the list of contacts 1262.

1. A computer-implemented method for managing business introductions comprising:
receiving, from an introduction requester via a network interface, a first indication of a type of person to whom the introduction requester would like to be introduced;
generating, with one or more processors, a notification message for display to a first plurality of business contacts of the introduction requester, the notification message indicating the introduction requester and the type of person;
for each of the first plurality of business contacts:
causing, with the one or more processors, the notification message to be displayed to the respective one of the first plurality of business contacts,
filtering, with the one or more processors, a second plurality of business contacts of the respective one of the first plurality of business contacts to identify a filtered list of business contacts, wherein each contact in the filtered list of contacts matches the type of person to whom the introduction requester would like to be introduced, and
causing, with the one or more processors, a selectable visual representation of the filtered list of contacts to be displayed to the respective one of the first plurality of business contacts; and
receiving, from one of the first plurality of business contacts via the network interface, a selection of one of the contacts in the filtered list of contacts displayed to the one of the first plurality of business contacts;
generating, with the one or more processors, an introduction message to the selected one of the contacts in the filtered list of contacts introducing the introduction requester to the selected one of the contacts in the filtered list of contacts; and
sending, via the network interface, the introduction message to the selected one of the contacts in the filtered list of contacts.

2. The computer-implemented method of claim 1, wherein each of the plurality of business contacts is indicated in at least one of a spreadsheet of contacts uploaded by the introduction requestor, communicated email contact data from an email messaging service, communicated social contact data from a social networking service, or communicated professional contact data from a professional networking service.

3. The computer-implemented method of claim 1, wherein receiving, from the introduction requester the first indication of the type of person to whom the introduction requester would like to be introduced includes receiving a keyword;

4. The computer-implemented method of claim 3, further comprising:
filtering, with the one or more processors, a comprehensive list of business contacts corresponding to the introduction requester based on the keyword to produce the first plurality of business contacts, wherein each of the first plurality of business contacts is connected to at least one person matching the type of person to whom the introduction requester would like to be introduced.

5. The computer-implemented method of claim 1, wherein generating the introduction message to the selected one of the contacts in the filtered list of contacts includes:
retrieving a message template from a template database; and
customizing the message template based on the selected one of the contacts in the filtered list of contacts and the one of the first plurality of business contacts.

6. The computer-implemented method of claim 5, wherein the message template is generated by the introduction requestor.

7. The computer-implemented method of claim 5, wherein generating the introduction message to the selected one of the contacts in the filtered list of contacts further includes:
customizing the message template based on user preferences corresponding to the introduction requestor.

8. The computer-implemented method of claim 7, wherein the user preferences include appointment scheduling preferences.

9. The computer-implemented method of claim 7, wherein the user preferences include appointment scheduling preferences and meeting type preferences.

10. The computer-implemented method of claim 1, wherein the introduction message is an email message.

11. The computer-implemented method of claim 1, wherein the introduction message is at least one of audio, video, image, or mobile text based message.

12. The computer-implemented method of claim 1, wherein the introduction message includes a substitutive variable.

13. The computer-implemented method of claim 12, wherein sending the introduction message includes substituting a text value for the substitutive variable in the introduction message.

14. The computer-implemented method of claim 12, wherein the text value is a Uniform Resource Locator (URL) link.

15. The computer-implemented method of claim 14, wherein the URL link directs the selected one of the contacts in the filtered list of contacts to a web page to accept or reject a request for a business introduction meeting.

16. The computer-implemented method of claim 12, wherein the text value is at least one of a name, email address, phone number, geographic location, company name, industry name, or job title.

17. The computer-implemented method of claim 1, further comprising:
storing, with the one or more processors, a record of the introduction message in a message database.

18. A computer device managing business introductions comprising:
one or more processors; and
one or more non-transitory memories coupled to the one or more processors;
wherein the one or more memories include computer executable instructions stored therein that, when executed by the one or more processors, cause the one or more processors to:
receive, from an introduction requester via a network interface, a first indication of a type of person to whom the introduction requester would like to be introduced,
generate a notification message for display to a first plurality of business contacts of the introduction requester, the notification message indicating the introduction requester and the type of person,
for each of the first plurality of business contacts:
cause the notification message to be displayed to the respective one of the first plurality of business contacts,
filter a second plurality of business contacts of the respective one of the first plurality of business contacts to identify a filtered list of business contacts, wherein each contact in the filtered list of contacts matches the type of person to whom the introduction requester would like to be introduced, and
cause a selectable visual representation of the filtered list of contacts to be displayed to the respective one of the first plurality of business contacts, and
receive, from one of the first plurality of business contacts via the network interface, a selection of one of the contacts in the filtered list of contacts displayed to the one of the first plurality of business contacts;
generate an introduction message to the selected one of the contacts in the filtered list of contacts introducing the introduction requester to the selected one of the contacts in the filtered list of contacts; and
send, via the network interface, the introduction message to the selected one of the contacts in the filtered list of contacts.

19. The computer device of claim 18, wherein receiving, from the introduction requester the first indication of the type of person to whom the introduction requester would like to be introduced includes a keyword.

20. The computer device of claim 19, wherein the computer executable instructions further cause the one or more processors to:
filter a comprehensive list of business contacts corresponding to the introduction requester based on the keyword to produce the first plurality of business contacts, wherein each of the first plurality of business contacts is connected to at least one person matching the type of person to whom the introduction requester would like to be introduced.

21. The computer device of claim 18, wherein the introduction message is an email message.

22. The computer device of claim 18, wherein each of the plurality of business contacts is indicated in at least one of a spreadsheet of contacts uploaded by the introduction requestor, communicated email contact data from an email messaging service, communicated social contact data from a social networking service, or communicated professional contact data from a professional networking service.
